(19) United States
(12) Patent Application Publication
(10) Pub. No.: US 2022/0375258 A1
(43) Pub. Date: Nov. 24, 2022

(54) IMAGE PROCESSING METHOD AND APPARATUS, DEVICE AND STORAGE MEDIUM

(71) Applicant: GUANGZHOU HUYA TECHNOLOGY CO., LTD, Guangdong (CN)

(72) Inventors: Luyan HUA, Guangdong (CN); Ligao LAI, Guangdong (CN)

(73) Assignee: GUANGZHOU HUYA TECHNOLOGY CO., LTD, Guangdong (CN)

(21) Appl. No.: 17/638,513

(22) PCT Filed: Oct. 27, 2020
(86) PCT No.: PCT/CN2020/123936

§ 371 Date: Feb. 25, 2022

(30) Foreign Application Priority Data
Oct. 29, 2019 (CN) 201911037748.8
Nov. 5, 2019 (CN) 201911072932.6

(51) Int. Cl. G06V 40/16

(52) U.S. Cl. CPC G06V 40/171; G06V 40/172; G06V 40/176

(57) ABSTRACT

An image processing method, an image processing apparatus, a device and a storage medium. The method includes: generating a human face key-point adjustment parameter set according to a current human face key-point set and historic human face key-point set corresponding respectively to a current human face image and historic human face image; acquiring an avatar face key-point set of an avatar face image matching the historic human face image, where the avatar face human face image is marked off into multiple original grids according to the avatar face key-points; generating an adjusted avatar face key-point set matching the avatar face key-point set according to the human face key-point adjustment parameter set; and adjusting the multiple original grids in the avatar face image according to the adjusted avatar face key-point set to generate an adjusted avatar face image corresponding to the current human face image.

### CROSS-REFERENCE TO RELATED APPLICATION(S)

This is a national stage application filed under 37 U.S.C. 371 based on International Patent Application No. PCT/CN2020/123936, filed Oct. 27, 2020, which claims priorities to Chinese Patent Application No. 201911037748.8 filed Oct. 29, 2019 and Chinese Patent Application No. 201911072932.6 filed Nov. 5, 2019, the disclosures of the three of which are incorporated herein by reference in their entireties.

### FIELD

Embodiments of the present disclosure relate to the technical field of image processing, for example, to an image processing method, an image processing apparatus, a device, and a storage medium.

### BACKGROUND

With the development of society, electronic devices such as mobile phones, tablet computers have been widely used in learning, entertainment, working and other aspects, many electronic devices are equipped with a camera for photographing, video recording, live broadcasting and other operations. When the image data of the camera includes a human face, a static avatar image (for example, a virtual human face image) can be made to follow the expression transformation of the human face to realize various action effects.

Because the size or shape of the avatar image is quite different from that of the human face in the camera, it is difficult for the avatar image to follow the human face for facial-expression transformation in real-time. Only when the size or shape of the avatar image is approximate to the size or shape of the human face in the image data of the camera, the avatar image can follow the human face for facial-expression transformation, and human face grid data of the avatar image is usually used to construct a muscle motion model of the human face, and the avatar image is controlled to follow the human face for facial-expression transformation by displacement of image.

The following disadvantages exist in the related art: either the sizes and shapes of the human face in the camera or the avatar image is limited, and it is complex to realize the avatar image to follow the human face for facial-expression transformation, resulting in that the transformation speed is slow, which is not adapted for following the human face for facial-expression transformation.

### SUMMARY

An image processing method, an image processing apparatus, a device, and a storage medium are provided according to the present disclosure, by which, the sizes and shapes of the human face in the camera and the avatar face in the avatar face image are not limited, and the speed of the avatar face image to follow the human face for facial-expression transformation is improved, which is adapted for following the human face for facial-expression transformation.

Embodiments of the present disclosure provide an image processing method, which includes:

generating a human face key-point adjustment parameter set according to a current human face key-point set and a historical human face key-point set, where the current human face key-point set and the historical human face key-point set correspond to a current human face image and a historical human face image respectively;

acquiring an avatar face key-point set of an avatar face image matching the historical human face image, where the avatar face image is marked off into multiple original grids according to avatar face key-points;

generating an adjusted avatar face key-point set matching the avatar face key-point set according to the human face key-point adjustment parameter set; and

adjusting the multiple original grids in the avatar face image according to the adjusted avatar face key-point set, to generate an adjusted avatar face image corresponding to the current human face image.

Embodiments of the present disclosure provide an image processing apparatus, which includes:

an adjustment parameter generating module configured to generate a human face key-point adjustment parameter set according to a current human face key-point set and a historical human face key-point set, where the current human face key-point set and the historical human face key-point set correspond to a current human face image and a historical human face image respectively;

a key-point acquiring module configured to acquire an avatar face key-point set of an avatar face image matching the historical human face image, where the avatar face image is marked off into multiple original grids according to virtual human face key-points;

a key-point adjustment module configured to generate an adjusted avatar face key-point set matching the avatar face key-point set according to the human face key-point adjustment parameter set; and

a virtual face adjustment module configured to adjust the multiple original grids in the avatar face image according to the adjusted avatar face key-point set, to generate an adjusted avatar face image corresponding to the current human face image.

The embodiments of the present disclosure further provide a device, which includes:

at least one processor; and

a storage device configured to store at least one program, and

the at least one program, when executed by at least one processor, causes the at least one processor to implement the image processing method according to any embodiment of the present disclosure.

Embodiments of the present disclosure further provide a computer-readable storage medium on which a computer program is stored, and the computer program, when executed by a processor, causes the processor to implement the image processing method according to any embodiment of the present disclosure.

### BRIEF DESCRIPTION OF DRAWINGS

FIG. 1 is a flowchart of an image processing method according to a first embodiment of the present disclosure;

FIG. 2a is a flowchart of an image processing method according to a second embodiment of the present disclosure;

FIG. 2b is a schematic view showing human face key-points according to a second embodiment of the present disclosure;

FIG. 2c is a schematic view showing original grids in a human face image according to the second embodiment of the present disclosure;

FIG. 2d is a schematic diagram showing grid matching according to the second embodiment of the present disclosure;

FIG. 3a is a flowchart of an image processing method according to a third embodiment of the present disclosure;

FIG. 3b is a schematic view showing an interocular distance of a human face image according to the third embodiment of the present disclosure;

FIG. 3c is a schematic view of a human face locating rectangle according to the third embodiment of the present disclosure;

FIG. 4a is a flowchart of an image processing method according to a fourth embodiment of the present disclosure;

FIG. 4b is a schematic view showing human face key-points according to the fourth embodiment of the present disclosure;

FIG. 5a is a flowchart of an image processing method according to a fifth embodiment of the present disclosure;

FIG. 5b is a schematic view of a locating rectangle for an eye peripheral region according to the fifth embodiment of the present disclosure;

FIG. 5c is a schematic view of a locating rectangle for a mouth peripheral region according to the fifth embodiment of the present disclosure;

FIG. 5d is a schematic view showing locating rectangles corresponding to respective regions of an avatar face according to the fifth embodiment of the present disclosure;

FIG. 6 is a schematic diagram of an image processing apparatus according to a sixth embodiment of the present disclosure; and

FIG. 7 is a schematic diagram of a device according to a seventh embodiment of the present disclosure.

### DETAILED DESCRIPTION

The present disclosure is described hereinafter in conjunction with drawings and embodiments. The embodiments described herein are intended to explain rather than limiting the present disclosure. In addition, for ease of description, only part of structures related to the present disclosure instead of all structures related thereto are illustrated in the drawings.

The present disclosure is described hereinafter in conjunction with drawings and embodiments. The embodiments described herein are intended to explain rather than limiting the present disclosure. In addition, for ease of description, only part of structures related to the present disclosure instead of all structures related thereto are illustrated in the drawings.

### FIRST EMBODIMENT

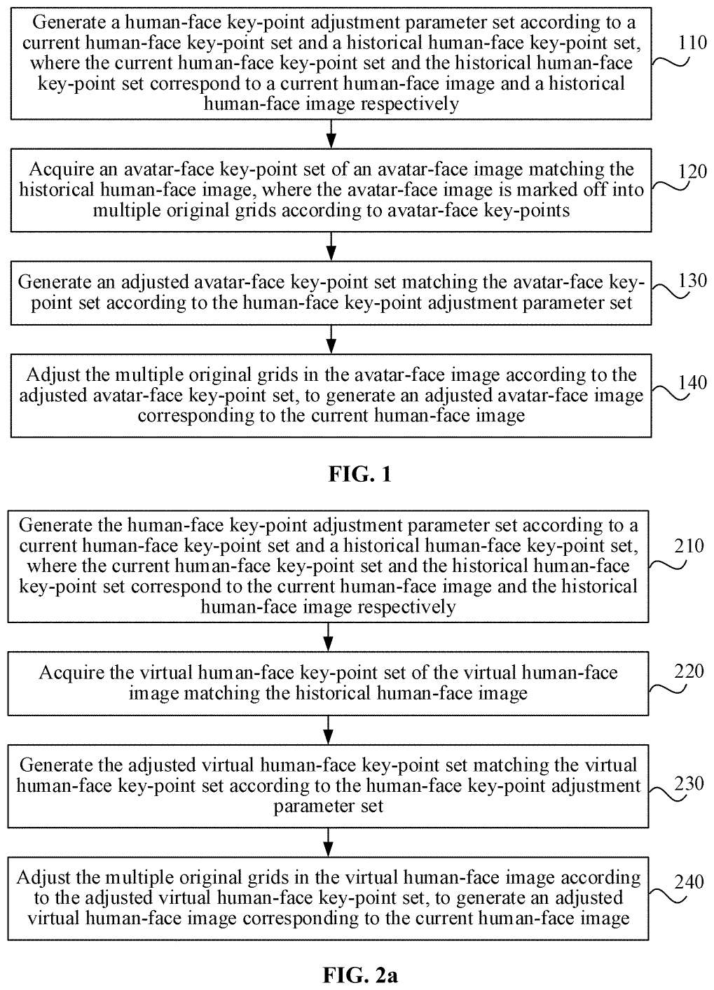

FIG. 1 is a flowchart of an image processing method according to a first embodiment of the present disclosure, this embodiment is applicable to a case where a virtual human face image follows a human face for facial-expression transformation in real time, the method may be performed by an image processing apparatus, and the device may be embodied by hardware and/or software, and may be generally integrated in a device providing an image processing service. As shown in FIG. 1a, the method includes the following steps 110, 120, 130 and 140.

The step 110 includes: generating a human face key-point adjustment parameter set according to a current human face key-point set and a historical human face key-point set, where the current human face key-point set and the historical human face key-point set correspond to a current human face image and a historical human face image respectively.

The step 120 includes: acquiring an avatar face key-point set of an avatar face image matching the historical human face image, where the avatar face image is marked off into multiple original grids according to avatar face key-points.

The step 130 includes: generating an adjusted avatar face key-point set matching the avatar face key-point set according to the human face key-point adjustment parameter set.

The step 140 includes: adjusting the multiple original grids in the avatar face image according to the adjusted avatar face key-point set, to generate an adjusted avatar face image corresponding to the current human face image.

This embodiment addresses the problem in the related art that the size and shape of the human face in the camera or the size and shape of the avatar face in the avatar face image is limited, and the speed of expression transformation of the avatar face image following the human face is slow. Accordingly, the sizes and shapes of the human face in the camera and the avatar face in the avatar face image are not limited, and the speed of the facial-expression transformation of the avatar face image following the human face is improved, which is adaptable to follow the human face for expression transformation in real-time.

### SECOND EMBODIMENT

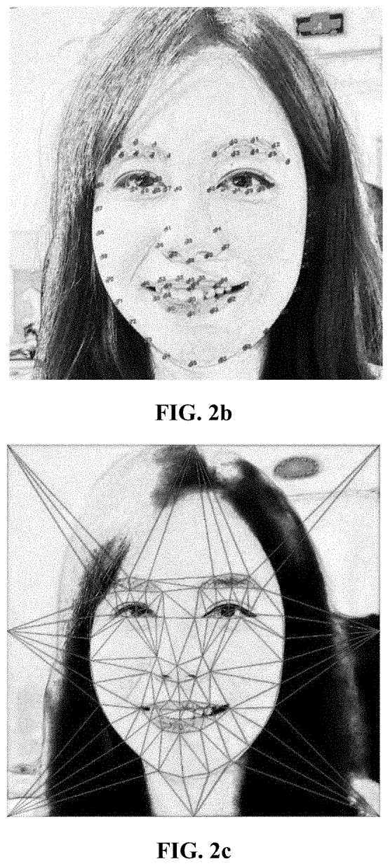

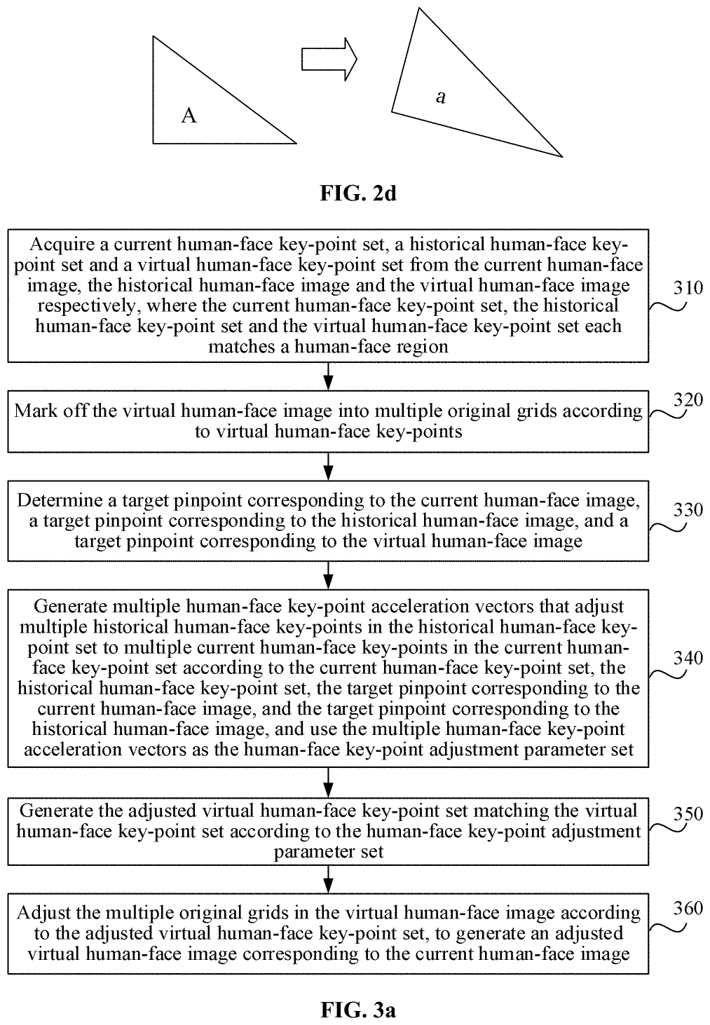

FIG. 2a is a flowchart of an image processing method according to a second embodiment of the present disclosure. Referring to FIG. 2a, this embodiment may be combined with multiple alternatives in the above embodiments. Referring to FIG. 2a, the method may include the following steps 210, 220, 230, and 240.

The step 210 includes: generating a human face key-point adjustment parameter set according to a current human face key-point set and a historical human face key-point set, where the current human face key-point set and the historical human face key-point set correspond to a current human face image and a historical human face image respectively.

In this embodiment, each of the current human face image and the historical human face image refers to a picture with a human face, which may be a selfie or a photograph of a user, a screenshot of a person in a video or a live broadcast, and the like, and the human face in the historical human face image is the same as the human face in the current human face image, except that a shooting time of the historical human face image is earlier than that of the current human face image. For example, the historical human face image may be a screenshot of a person when the live broadcast proceeds to 11 minutes 12 seconds, and the current human face image may be a screenshot of the person when the live broadcast proceeds to 11 minutes 13 seconds.

In some embodiments, by performing human face detection on the human face image, human face key-points included in the human face image can be recognized, that is, the positions of key-regions of the human face, including eyebrows, eyes, the nose, the mouth, the human face contour, and the like, as shown in FIG. 2b, are located, and a human face key-point set corresponding to the human face image can be obtained. The number of human face key-points may be set according to actual situations.

In some embodiments, before the generating a human face key-point adjustment parameter set according to a current human face key-point set and a historical human face key-point set, where the current human face key-point set and the historical human face key-point set correspond to a current human face image and a historical human face image respectively, the method may further include: determining a target pinpoint corresponding to the current human face image, a target pinpoint corresponding to the historical human face image, and a target pinpoint corresponding to the virtual human face image.

In this embodiment, the virtual human face image is a static human face image, which needs to follow the facial-expression transformation of the human face in front of the camera, that is, the change from a historical human face image to a current human face image to make corresponding actions in real time. In order to determine the correspondence relationship between the current human face image and the historical human face image, and the correspondence relationship between the historical human face image and the virtual human face image, it is necessary to first determine a target pinpoint in the current human face image, a target pinpoint in the historical human face image, and a target pinpoint in the virtual human face image each as a reference position point, the position of the target pinpoint in the current human face image, the position of the target pinpoint in the historical human face image, and the position of the target pinpoint in the virtual human face image are the same, and the correspondence relationships among the multiple human face key-points in the current human face image, the multiple human face key-points in the historical human face image and the multiple human face key-points in the virtual human face image are determined according to the relative positional relationships among their corresponding target pinpoints.

In some embodiments, the determining a target pinpoint corresponding to the current human face image, a target pinpoint corresponding to the historical human face image, and a target pinpoint corresponding to the virtual human face image may include: determining human face locating rectangles in the current human face image, the historical human face image, and the virtual human face image, respectively; and acquiring corner-points having the same orientation in the human face locating rectangles respectively, and using the corner-points having the same orientation as target pinpoints of the current human face image, the historical human face image, and the virtual human face image respectively.

In this embodiment, human face locating rectangles covering the current human face region, the historical human face region, and the virtual human face region respectively can be determined according to the human face key-point sets respectively corresponding to the current human face image, the historical human face image, and the virtual human face image. In this embodiment, a human face locating rectangle may be replaced with another polygon such as a square, a pentagon, or a circle, and corner-points having the same orientation in the human face locating rectangles of the current human face image, the historical human face image, and the virtual human face image are acquired as target pinpoints for determining correspondence relationships between the human face key-points in the current human face image, the historical human face image, and the virtual human face image.

In some embodiments, the generating a human face key-point adjustment parameter set according to a current human face key-point set and a historical human face key-point set, where the current human face key-point set and the historical human face key-point set correspond to a current human face image and a historical human face image respectively may include: generating multiple human face key-point acceleration vectors that adjust multiple historical human face key-points in the historical human face key-point set to multiple current human face key-points in the current human face key-point set according to the current human face key-point set, the historical human face key-point set, the target pinpoint corresponding to the current human face image, and the target pinpoint corresponding to the historical human face image, and using the multiple human face key-point acceleration vectors as the human face key-point adjustment parameter set.

In this embodiment, by taking the target pinpoints corresponding to the current human face image and the historical human face image respectively as the reference position points, a change value of the current human face key-point set relative to the historical human face key-point set, i.e., the human face key-point acceleration vectors, can be determined. In this embodiment, the human face key-point acceleration vector may be a differential vector obtained by vector subtraction between a vector of the current human face key-point relative to the corresponding target pinpoint and a vector of the historical human face key-point relative to the corresponding target pinpoint. The differential vector may be represented in a form of coordinates, or may be represented in a form of a mold and an included angle, in which the included angle and the mold length respectively represent a vector angle change and a vector mold length change that occur when the vector of the historical human face key-point relative to the corresponding target pinpoint is rotated to the vector of the current human face key-point relative to the corresponding target pinpoint.

The step 220 includes: acquiring a virtual human face key-point set of a virtual human face image matching the historical human face image.

In this embodiment, the virtual human face image is composed of multiple original grids formed by dividing the virtual human face image with the virtual human face key-points. A grid represents an individual drawable entity, and a vertex of the grid include at least a human face key-point, that is, the human face key-points are used as at least part of the vertexes of the grid, and the human face image data is gridded into two or more grids, as shown in FIG. 2c.

In this embodiment, the human face expression in the virtual human face image is consistent with the human face expression in the historical human face image, and the virtual human face expression can be adjusted correspondingly according to the change from the historical human face expression to the current human face expression, and the virtual human face key-point set of the virtual human face image needs to be acquired before making human face expression adjustment to the virtual human face image.

The step 230 includes: generating an adjusted virtual human face key-point set matching the virtual human face key-point set according to the human face key-point adjustment parameter set.

In some embodiments, the generating an adjusted virtual human face key-point set matching the virtual human face key-point set according to the human face key-point adjustment parameter set may include: generating the adjusted virtual human face key-point set according to the human face key-point adjustment parameter set and the target pinpoint corresponding to the virtual human face image.

In this embodiment, the human face key-point adjustment parameter set reflects the changes of multiple human face key-points from the historical human face expression to the current human face expression, and also the changes of multiple virtual human face key-points before and after the adjustment of the virtual human face expression. Therefore, when the target pinpoint corresponding to the virtual human face image is consistent with the target pinpoint corresponding to the historical human face image, the target pinpoint is taken as the reference position point, and the changes of multiple virtual human face key-points before and after the virtual human face expression adjustment are added to the virtual human face key-points to obtain the adjusted virtual human face key-point set.

The step 240 includes: adjusting the multiple original grids in the virtual human face image according to the adjusted virtual human face key-point set, to generate an adjusted virtual human face image corresponding to the current human face image.

In some embodiments, the adjusting the multiple original grids in the virtual human face image according to the adjusted virtual human face key-point set, to generate an adjusted virtual human face image corresponding to the current human face image may include: establishing a blank image matching the virtual human face image; determining grid deformation modes of the multiple original grids in the virtual human face image according to the adjusted virtual human face key-point set; marking off the blank image into multiple object deformed grids corresponding to the multiple original grids according to the grid deformation modes; and mapping multiple pixels in each original grid into an object deformed grid corresponding to the respective original grid according to positional correspondence relationships between the multiple original grids and the multiple object deformed grids to obtain the adjusted virtual human face image.

In this embodiment, after the adjusted virtual human face key-point set is determined, a blank image corresponding to the size of the human face in the virtual human face image may be established, so that the object deformed grids corresponding to the original grids are marked off on the blank image subsequently, and the adjusted virtual human face is displayed on the blank image after deformation adjustment is performed on the multiple original grids in the virtual human face to obtain the adjusted virtual human face image.

In some embodiments, it is possible to determine the grid deformation modes of the multiple original grids in the virtual human face image by comparing the adjusted virtual human face key-point set with the unadjusted virtual human face key-point set, for example, a vertex c in an original grid s is moved to a specified position point c′; and a vertex d is moved to a specified position point d′; and then on the blank image, an object deformed grid corresponding to the original grid s may be marked off according to the original grid s and the corresponding grid deformation mode.

In this embodiment, in order to accelerate the processing to the virtual human face image, after multiple object deformed grids corresponding to the multiple original grids are marked off, pixels in the multiple original grids are mapped into the corresponding object deformed grids one by one directly according to the mapping relationships between the original grids and the object deformed grids without re-rendering the pixels in the original grids into the object deformed grids.

In some embodiments, the mapping multiple pixels in each original grid into an object deformed grid corresponding to the respective original grid according to positional correspondence relationships between the multiple original grids and the multiple object deformed grids to obtain the adjusted virtual human face image may include: acquiring one of the original grids in the virtual human face image as a current processing grid; acquiring, on the blank image, an object deformed grid matching the current processing grid, and using the object deformed grid matching the current processing grid as a matching grid; obtaining a first vertex sequence corresponding to the current processing grid and a second vertex sequence corresponding to the matching grid, and calculating a mapping relationship matrix between the current processing grid and the matching grid according to the first vertex sequence and the second vertex sequence; and mapping multiple pixels in the current processing grid to the matching grid according to the mapping relationship matrix, and returning to perform the operation of acquiring one of the original grids in the virtual human face image as a current processing grid until all the plurality of original grids in the virtual human face image have been processed.

In this embodiment, when mapping the pixels in the multiple original grids in the virtual human face image, firstly, one original grid in the virtual human face image may be selected from the multiple original grids as the current processing grid, for example, an original grid A may be selected from the multiple original grids as the current processing grid, and an object deformed grid a matching the current processing grid is marked off on the blank image and is used as a matching grid, as shown in FIG. 2d. A first vertex sequence (x1, y1), (x2, y2), (x3, y3) corresponding to the current processing grid A, that is, the coordinates of the three vertexes of the current processing grid A and a second vertex sequence (x1′, y1′), (x2′, y2′), (x3′, y3′) corresponding to the matching grid a are acquired, and further, a mapping relationship matrix between the current processing grid A and the matching grid a is calculated according to the coordinates of the vertexes of the current processing grid A and the matching grid a; and according to the mapping relationship matrix, coordinates of multiple pixels in the current processing grid A in the matching grid a can be obtained, and thereby realizing that the multiple pixels in the current processing grid A are directly mapped into the matching grid a. In the subsequent, one original grid is selected from the remaining original grids as a current processing grid, and the proceeding processes is repeated, until all the original grids in the virtual human face image are processed and the adjusted virtual human face image is obtained.

In the embodiment of the present disclosure, a human face key-point adjustment parameter set is generated according to a current human face key-point set and a historical human face key-point set, where the current human face key-point set and the historical human face key-point set correspond to a current human face image and a historical human face image respectively; a virtual human face key-point set of a virtual human face image matching the historical human face image is acquired, where the virtual human face image is marked off into multiple original grids according to virtual human face key-points; an adjusted virtual human face key-point set matching the virtual human face key-point set is generated according to the human face key-point adjustment parameter set; and multiple original grids in the virtual human face image are adjusted according to the adjusted virtual human face key-point set, to generate an adjusted virtual human face image corresponding to the current human face image. In such way, the method provided by this embodiment addresses the problem in the related art that the size and shape of the human face in the camera or the size and shape of the virtual human face image is limited, and the speed of expression transformation of the virtual human face image following the human face is slow. Accordingly, the sizes and shapes of the human face in the camera and the virtual human face image are not limited, and the speed of the facial-expression transformation of the virtual human face image following the human face is improved, which is adaptable to follow the human face for expression transformation in real-time.

### THIRD EMBODIMENT

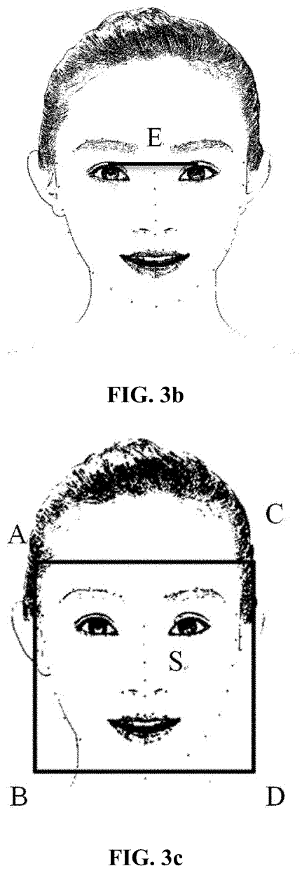

FIG. 3a is a flowchart of an image processing method in a third embodiment of the present disclosure. This embodiment may be combined with multiple alternatives in the above embodiments. Referring to FIG. 3a, the method may include the following steps 310, 320, 330, 340, 350 and 360.

The step 310 includes: acquiring a current human face key-point set, a historical human face key-point set and a virtual human face key-point set from the current human face image, the historical human face image and the virtual human face image respectively, where the current human face key-point set, the historical human face key-point set and the virtual human face key-point set each matches a human face region.

In this embodiment, in order to enable the virtual human face image to follow the change of the human face from the historical human face image to the current human face image and make corresponding action, the current human face key-point set, the historical human face key-point set and the virtual human face key-point set which match the human face region, need to be acquired from the current human face image, the historical human face image and the virtual human face image respectively, and the change of the human face key-points matching the change of the human face can be determined, and the adjustment operations to be performed can be determined for each of the multiple virtual human face key-points in the virtual human face image respectively.

The step 320 includes: marking off the virtual human face image into multiple original grids according to virtual human face key-points.

The step 330 includes: determining a target pinpoint corresponding to the current human face image, a target pinpoint corresponding to the historical human face image, and a target pinpoint corresponding to the virtual human face image.

In some embodiments, the determining a target pinpoint corresponding to the current human face image, a target pinpoint corresponding to the historical human face image, and a target pinpoint corresponding to the virtual human face image may include: determining human face locating rectangles in the current human face image, the historical human face image, and the virtual human face image, respectively; acquiring corner-points having the same orientation in the human face locating rectangles respectively, and using the corner-points having the same orientation as target pinpoints of the current human face image, the historical human face image, and the virtual human face image respectively.

In some embodiments, the determining a human face locating rectangle in the current human face image, a human face locating rectangle in the historical human face image, and a human face locating rectangle in the virtual human face image, may include: acquiring an interocular distance in the current human face image, a nose tip key-point of the current human face image, an interocular distance in the historical human face image, a nose tip key-point of the historical human face image, an interocular distance in the virtual human face image and a nose tip key-point of the virtual human face image; and constructing the human face locating rectangle corresponding to the current human face image by taking a product of the interocular distance in the current human face image and the first proportion value as a length, a product of the interocular distance in the current human face image and the second proportion value as a width, and the nose tip key-point of the current human face image as a center point, the human face locating rectangle corresponding to the historical human face image by taking a product of the interocular distance in the historical human face image and the first proportion value as a length, a product of the interocular distance in the historical human face image and the second proportion value as a width, and the nose tip key-point of the historical human face image as a center point, and the human face locating rectangle corresponding to the virtual human face image by taking a product of the interocular distance in the virtual human face image and the first proportion value as a length, a product of the interocular distance in the virtual human face image and the second proportion value as a width, and the nose tip key-point of the virtual human face image as a center point. Among which, the interocular distance and the nose tip key-point aforementioned are determined according to the corresponding human face key-point set.

As an example, the current human face image is taken for illustration. As shown in FIG. 3b, the interocular distance E in the current human face image can be obtained simply by acquiring the coordinates of the human face key-points of both eyes in the current human face key-point set corresponding to the current human face image and making a subtraction therebetween. According to experience, the first proportion value can be set as 2, and the second proportion value can be set as 2.5, so as to obtain the human face locating rectangle with a length as 2*E, a width as 2.5*E and a center point as the nose tip key-point S, as shown in FIG. 3c. Apparently, the first proportion value and the second proportion value may also be set as other values.

The step 340 includes: generating multiple human face key-point acceleration vectors that adjust multiple historical human face key-points in the historical human face key-point set to multiple current human face key-points in the current human face key-point set according to the current human face key-point set, the historical human face key-point set, the target pinpoint corresponding to the current human face image, and the target pinpoint corresponding to the historical human face image, and using the multiple human face key-point acceleration vectors as the human face key-point adjustment parameter set.

In some embodiments, the generating multiple human face key-point acceleration vectors that adjust multiple historical human face key-points in the historical human face key-point set to multiple current human face key-points in the current human face key-point set according to the current human face key-point set, the historical human face key-point set, the target pinpoint corresponding to the current human face image, and the target pinpoint corresponding to the historical human face image, and using the multiple human face key-point acceleration vectors as the human face key-point adjustment parameter set may include: acquiring first position vectors between each current human face key-point in the current human face key-point set and the target pinpoint corresponding to the current human face image, and second position vectors between each of the historical human face key-points in the historical human face key-point set and the target pinpoint corresponding to the historical human face image; calculating vector differences between each of the second position vectors and a respective one of the first position vectors corresponding to each of the second position vectors; and calculating a product of each of the vector differences and a human face scaling to obtain the human face key-point acceleration vectors matching each of the historical human face key-points, and using the human face key-point acceleration vectors matching each of the historical human face key-points as the human face key-point adjustment parameter set.

As an example, as shown in FIG. 3c, it is assumed that both the current human face image and the historical human face image take the vertex A of the human face locating rectangle as the target pinpoint. The first position vectors XnA between each of the current human face key-points Xn and the target pinpoint A and the second position vectors Xn′A between each of the historical human face key-points Xn′ are acquired, and by calculating XnA-Xn′A, the coordinate change of each human face key-point corresponding to the human face change from a historical human face image to the current human face image is obtained. Considering that the size of the human face in the historical face image is inconsistent with the size of the human face in the virtual human face image, it is required to calculate the acceleration vector of each human face key-point according to the formula an=(XnA-Xn′A)×Q, that is, adjustment parameters for all the human face key-points, making the calculated coordinate changes of all the human face key-points fit the size of the virtual human face. Among which, Q is a human face scaling, and n is an integer greater than or equal to 1.

In some embodiments, before the calculating the product of each of the vector differences and the human face scaling, it may further include using a quotient value obtained by dividing the interocular distance in the virtual human face image by the interocular distance in the current human face image as the human face scaling.

In this embodiment, since the virtual human face image is a static image, the interocular distance in the virtual human face does not change, and when the size of the human face in front of the camera changes, in order to ensure that the calculated coordinate changes of the multiple human face key-points fit the size of the virtual human face, the quotient value of the interocular distance in the virtual human face image and the interocular distance in the current human face image can be used as the human face scaling to scale down or up the coordinate changes of the multiple human face key-points.

The step 350 includes: generating an adjusted virtual human face key-point set matching the virtual human face key-point set according to the human face key-point adjustment parameter set.

In some embodiments, the generating the adjusted virtual human face key-point set according to the human face key-point adjustment parameter set and the target pinpoint corresponding to the virtual human face image may include acquiring third position vectors between each virtual human face key-point in the virtual human face key-point set and the target pinpoint corresponding to the virtual human face image; and calculating vector sum values of each of the third position vectors and a corresponding human face key-point acceleration vector in the human face key-point adjustment parameter set, and calculating the adjusted virtual human face key-point set according to the multiple vector sum values and the target pinpoint corresponding to the virtual human face image.

In this embodiment, after the human face key-point adjustment parameters corresponding to the multiple historical human face key-points are obtained, the multiple human face key-point adjustment parameters are added to the corresponding multiple virtual human face key-points to obtain the position vectors between the multiple adjusted virtual human face key-points and the target pinpoint, and by performing vector subtraction between the coordinate of the target pinpoint and the position vectors, the multiple adjusted virtual human face key-points can be obtained.

The step 360 includes: adjusting the multiple original grids in the virtual human face image according to the adjusted virtual human face key-point set, to generate an adjusted virtual human face image corresponding to the current human face image.

In the embodiments of the present disclosure, a human face key-point adjustment parameter set is generated according to a current human face key-point set and a historical human face key-point set, where the current human face key-point set and the historical human face key-point set correspond to a current human face image and a historical human face image respectively; a virtual human face key-point set of a virtual human face image matching the historical human face image is acquired, where the virtual human face image is marked off into multiple original grids according to virtual human face key-points; an adjusted virtual human face key-point set matching the virtual human face key-point set is generated according to the human face key-point adjustment parameter set; and multiple original grids in the virtual human face image are adjusted according to the adjusted virtual human face key-point set, and an adjusted virtual human face image corresponding to the current human face image is generated. This embodiment addresses the problem in the related art that the size and shape of the human face in the camera or the size and shape of the virtual human face image is limited, and the speed of expression transformation of the virtual human face image following the human face is slow. Accordingly, the sizes and shapes of the human face in the camera and the virtual human face image are not limited, and the speed of the facial-expression transformation of the virtual human face image following the human face is improved, which is adaptable to follow the human face for expression transformation in real-time.

### FOURTH EMBODIMENT

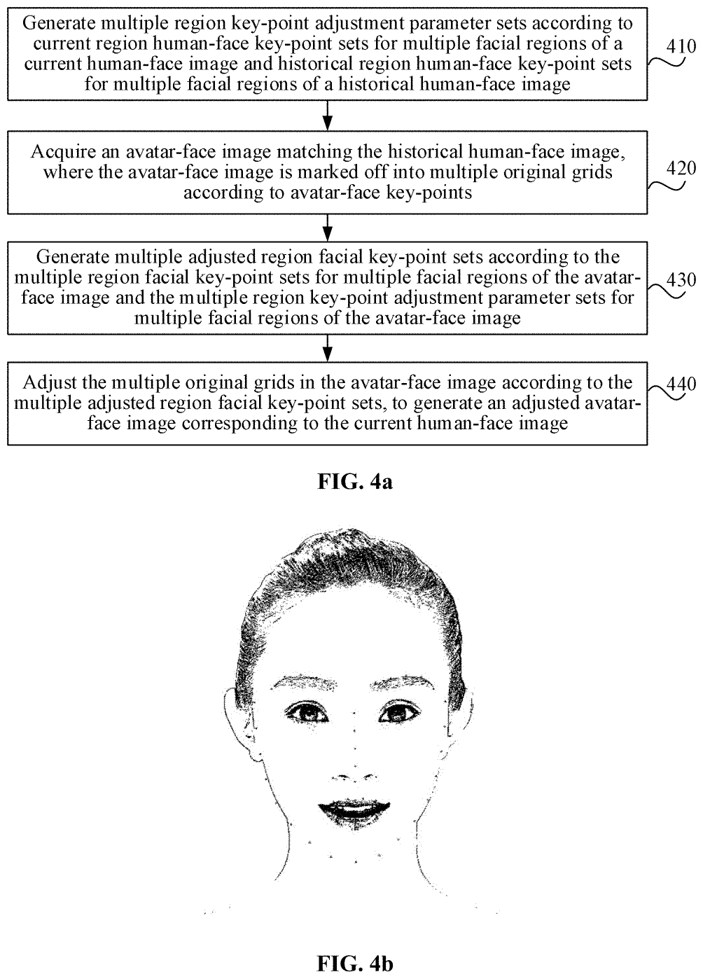

FIG. 4a is a flowchart of an image processing method in a fourth embodiment of the present disclosure. This embodiment is applicable to a case where an avatar face image follows a human face for facial-expression transformation in real time, the method may be performed by an image processing apparatus, the image processing apparatus may be implemented by hardware and/or software, and may be generally integrated in a device providing an image processing service. As shown in FIG. 4a, the method includes steps 410, 420, 430, and 440.

The step 410 includes: generating multiple region key-point adjustment parameter sets according to current region human face key-point sets for multiple facial regions of the current human face image and historical region human face key-point sets for multiple facial regions of the historical human face image.

In this embodiment, each of the current human face image and the historical human face image refers to a picture with a human face, which may be a selfie or a photograph of a user, and may also be a screenshot of a person in a video or a live broadcast, or the like. The current human face image is obtained by expression transformation of the historical human face image, that is, the shooting time of the historical human face image is earlier than that of the current human face image. For example, the historical human face image may be a video screenshot of a person when the live broadcast proceeds to 11 minutes 12 seconds, and the current human face image is a video screenshot of the person when the live broadcast proceeds to 11 minutes 13 seconds.

In some embodiments, the facial region includes at least two of a facial contour region, an eye peripheral region, and a mouth peripheral region.

In this embodiment, since when a human face transforms expression, it is mainly that the muscles of a facial contour, eyes, eyes peripheral regions, a mouth and a mouth peripheral region change, so it is necessary to collect facial key-points for the facial contour region, the eye peripheral regions, and the mouth peripheral region to determine how the muscles of the corresponding regions change, that is, to determine how the human face key-points of the corresponding regions change.

In some embodiments, by performing human face detection on the human face image, human face key-points included in the human face image can be recognized, and the positions of key-regions of the human face, including eyebrows, eyes, the nose, the mouth, the human face contour, and the like, as shown in FIG. 4b, are located, and human face key-point sets for multiple facial regions of the human face image can be obtained. The number of human face key-points can be set according to the practical situation.

In some embodiments, before the generating multiple region key-point adjustment parameter sets according to current region human face key-point sets for multiple facial regions of the current human face image and historical region human face key-point sets for multiple facial regions of the historical human face image, the method may further include: determining target pinpoints for the multiple facial regions of the current human face image, target pinpoints for the multiple facial regions of the historical human face image, and target pinpoints for the multiple facial regions of the avatar face image.

In this embodiment, the avatar face image is a static image, which needs to follow facial-expression transformation of the human face in front of the camera, that is, the change from a historical human face image to a current human face image to make corresponding actions in real time. In order to determine the correspondence relationship between the current human face image and the historical human face image, and the correspondence relationship between the historical human face image and the avatar face image, it is necessary to first determine target pinpoints of multiple facial regions corresponding to the current human face image, target pinpoints of multiple facial regions corresponding to the historical human face image, and target pinpoints of multiple facial regions corresponding to the avatar face image each as reference orientation points, the orientations of the target pinpoints of the same facial region in the current human face image, the historical human face image, and the avatar face image are the same, for example, all at a left upper corner of the mouth peripheral region, and multiple human face key-points in each facial region of the current human face image, the historical human face image, and the avatar face image determine the correspondence relationship therebetween by their relative positional relationships with the corresponding target pinpoints.

In some embodiments, the determining target pinpoints for the multiple facial regions of the current human face image, target pinpoints for the multiple facial regions of the historical human face image, and target pinpoints for the multiple facial regions of the avatar face image may include: determining region locating rectangles corresponding to the current processing facial region in the current human face image, region locating rectangles corresponding to the current processing facial region in the historical human face image, and region locating rectangles corresponding to the current processing facial region in the avatar face image,; and in the multiple region locating rectangles aforementioned, acquiring corner-points having the same orientation respectively, and using the corner-points having the same orientation as target pinpoints corresponding to the current processing facial region.

In this embodiment, the region locating rectangle may be replaced with another polygon such as a square, a pentagon, or a circle. In the region locating rectangles, for each facial region, of the current human face image, the historical human face image, and the avatar face image, corner-points having the same orientation are respectively acquired, and are used as target pinpoints, so as to determine correspondence relationships between human face key-points in each facial region.

In some embodiments, the generating multiple region key-point adjustment parameter sets according to current region human face key-point sets for multiple facial regions of the current human face image and historical region human face key-point sets for multiple facial regions of the historical human face image may include: generating multiple region key-point adjustment acceleration vectors according to a current region human face key-point set corresponding to each facial region and a historical region human face key-point set corresponding to each facial region, target pinpoints corresponding to each facial region in the current human face image, and target pinpoints corresponding to each facial region in the historical human face image, and using the multiple region key-point adjustment acceleration vectors as the region key-point adjustment parameter set.

In this embodiment, by taking the target pinpoints corresponding to each facial region of the current human face image and the target pinpoints corresponding to each facial region of the historical human face image as reference orientation points, change values of the current human face key-point set relative to the historical human face key-point set for the respective facial region, i.e., key-point adjustment acceleration vectors for this region, can be determined.

In this embodiment, a region key-point adjustment acceleration vector may be a differential vector obtained by vector subtraction between a vector of a current human face key-point relative to its corresponding target pinpoint and a vector of a historical human face key-point relative to its corresponding target pinpoint, and the differential vector may be represented in a form of coordinates, or may be represented in a form of a mold and an included angle, and the included angle and the mold length respectively represent a vector angle change and a vector mold length change that occur when the vector of the historical human face key-point relative to its corresponding target pinpoint is rotated to the vector of the current human face key-point relative to its corresponding target pinpoint.

The step 420 includes: acquiring an avatar face image matching the historical human face image, where the avatar face image is marked off into multiple original grids according to avatar face key-points.

In this embodiment, the avatar face image is composed of multiple original grids formed by marking off the avatar face image with the avatar face key-points, a grid represents an individual drawable entity, and corner-points of the grid include at least avatar face key-points, that is, the avatar face key-points are used as at least part of the corner-points of the grid, to grid the avatar face image data into two or more grids, as shown in FIG. 2c.

In this embodiment, the facial-expression in the avatar face image is consistent with the facial-expression in the historical human face image, and the avatar face expression can be adjusted correspondingly according to the change from the historical human face expression to the current human face expression. The region facial key-point sets for multiple facial regions of the avatar face image are required to be acquired before making adjustment to the avatar face expression.

The step 430 includes: generating multiple adjusted region facial key-point sets according to the multiple region facial key-point sets for multiple facial regions of the avatar face image and the multiple region key-point adjustment parameter sets.

In some embodiments, the generating multiple adjusted region facial key-point sets according to the multiple region facial key-point sets for multiple facial regions of the avatar face image and the multiple region key-point adjustment parameter sets may include generating multiple adjusted region facial key-point sets according to the region facial key-point sets corresponding to each of the multiple facial regions and the region key-point adjustment parameter sets corresponding to each of the multiple facial regions, and the target pinpoints in the avatar face image.

In this embodiment, the multiple region key-point adjustment parameter sets reflect the changes of multiple human face key-points in multiple facial regions from the historical human face expression to the current human face expression, and also reflect the changes of multiple avatar face key-points in the multiple facial regions before and after the adjustment of the avatar face expression. Therefore, when the target pinpoints of each of the plurality of facial regions of the avatar face image are consistent with the target pinpoints of each of the plurality of facial regions of the historical human face image respectively, the target pinpoints are taken as the reference orientation points, and the avatar face key-points are each added with the change of the corresponding avatar face key-point, thus the multiple adjusted region facial key-point sets can be obtained.

The step 440 includes: adjusting the multiple original grids in the avatar face image according to multiple adjusted region facial key-point sets, to generate an adjusted avatar face image corresponding to the current human face image.

In some embodiments, the adjusting the multiple original grids in the avatar face image according to multiple adjusted region facial key-point sets, to generate an adjusted avatar face image corresponding to the current human face image may include: establishing a blank image matching the avatar face image; determining grid deformation modes of the multiple original grids in the avatar face image according to the multiple adjusted region facial key-point sets; marking off the blank image into multiple object deformed grids corresponding to the multiple original grids according to the grid deformation modes; and mapping multiple pixels in each original grid into an object deformed grid corresponding to the respective original grid according to positional correspondence relationships between the multiple original grids and the multiple object deformed grids to obtain the adjusted avatar face image.

In this embodiment, after the multiple adjusted region facial key-point set is determined, a blank image corresponding to the size of the avatar face in the avatar face image may be established, so that the object deformed grids corresponding to the original grids are formed by marking off the blank image subsequently, and the adjusted avatar face image is displayed.

In some embodiments, it is possible to determine the grid deformation modes of original grids of each facial region in the avatar face image by comparing the adjusted region facial key-point set with the unadjusted region facial key-point set, for example, a vertex c in an original grid s is moved to a specified position point c′; and a vertex d is moved to a specified position point d′; and then on the blank image, the object deformed grid corresponding to the original grid s may be marked off according to the original grid s and the corresponding grid deformation mode.

In this embodiment, in order to accelerate the processing to the avatar face image, after multiple object deformed grids corresponding to the multiple original grids are marked off, pixels in the multiple original grids are sequentially mapped into the corresponding object deformed grids one by one directly according to the mapping relationships between the multiple original grids and the multiple object deformed grids, and the pixels in the original grids need not to be re-rendered into the object deformed grids.

In some embodiments, the mapping multiple pixels in each original grid into an object deformed grid corresponding to the respective original grid according to positional correspondence relationships between the multiple original grids and the multiple object deformed grids to obtain the adjusted avatar face image may include: acquiring one of the original grids in the avatar face image as a current processing grid; acquiring, on the blank image, an object deformed grid matching the current processing grid, and using the object deformed grid matching the current processing grid as a matching grid; obtaining a first vertex sequence corresponding to the current processing grid and a second vertex sequence corresponding to the matching grid, and calculating a mapping relationship matrix between the current processing grid and the matching grid according to the first vertex sequence and the second vertex sequence; and mapping multiple pixels in the current processing grid to the matching grid according to the mapping relationship matrix, and returning to perform the operation of acquiring one of the original grids in the avatar face image as a current processing grid until all the plurality of original grids in the avatar face image have been processed.

In this embodiment, when to map the pixels in the multiple original grids of the multiple facial regions in the avatar face image, firstly, one original grid may be selected from the multiple original grids as the current processing grid, for example, an original grid A may be selected from the multiple original grids as the current processing grid, and then an object deformed grid a matching the current processing grid is marked off as a matching grid on the blank image, as shown in FIG. 2d. A first vertex sequence (x1, y1), (x2, y2), (x3, y3) corresponding to the current processing grid A, that is, the coordinates of the three corner-points of the current processing grid A and a second vertex sequence (x1′, y1′), (x2′, y2′), (x3′, y3′) corresponding to the matching grid a are acquired then, and further, a mapping relationship matrix between the current processing grid and the matching grid is calculated according to the coordinates of the corner-points of the current processing grid A and the matching grid a; and according to the mapping relationship matrix, coordinates of multiple pixels in the current processing grid A in the matching grid can be obtained, and thereby realizing that the multiple pixels in the current processing grid A are directly mapped into the matching grid a. Then, one original grid is selected from the remaining original grids as the current processing grid, and the above process is repeated, till all the original grids in the avatar face image are processed and the adjusted avatar face image is obtained.

In the embodiment of the present disclosure, the multiple region key-point adjustment parameter sets are generated according to current region human face key-point sets for multiple human face regions of the current human face image and historical region human face key-point sets for multiple human face regions of the historical human face image; an avatar face image matching the historical human face image is acquired, where the avatar face image is marked off into multiple original grids according to avatar face key-points; multiple adjusted region facial key-point sets are generated according to the multiple region facial key-point sets and the multiple region key-point adjustment parameter sets for multiple facial regions of the avatar face image; and the multiple original grids in the avatar face image are adjusted according to the multiple adjusted region facial key-point sets, and an adjusted avatar face image corresponding to the current human face image is generated. This embodiment addresses the problem in the related art that the size and shape of the human face in the camera or the size and shape of the avatar face in the avatar face image is limited, and the speed of expression transformation of the avatar driven by the human face is slow, and accordingly, the sizes and shapes of the human face in the camera and the avatar face in the avatar face image are not limited, and the speed and accuracy of the facial-expression transformation of the avatar image driven by the human face is improved, which is adaptable to follow the human face for expression transformation in real time.

### FIFTH EMBODIMENT

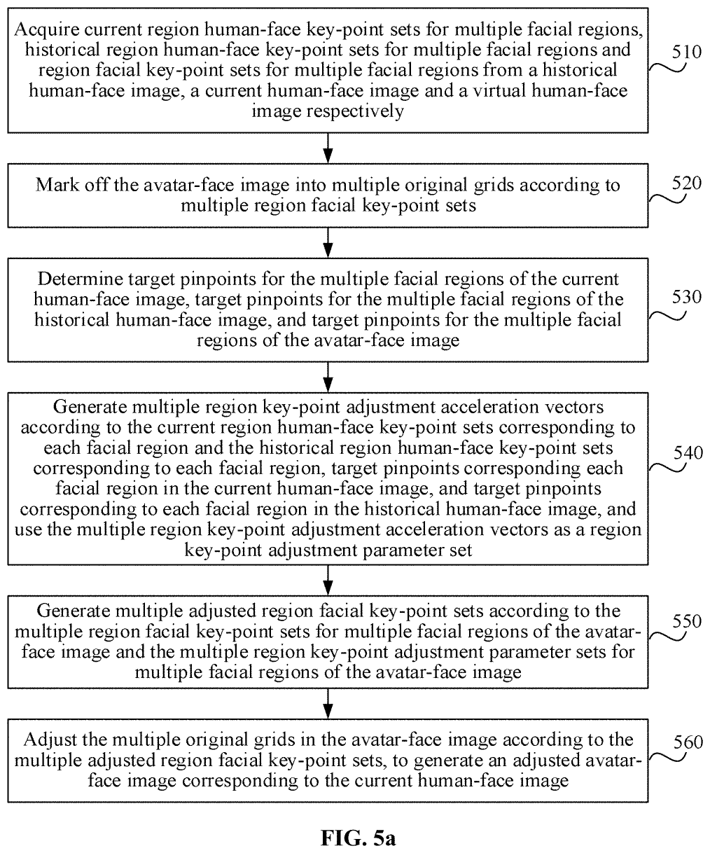

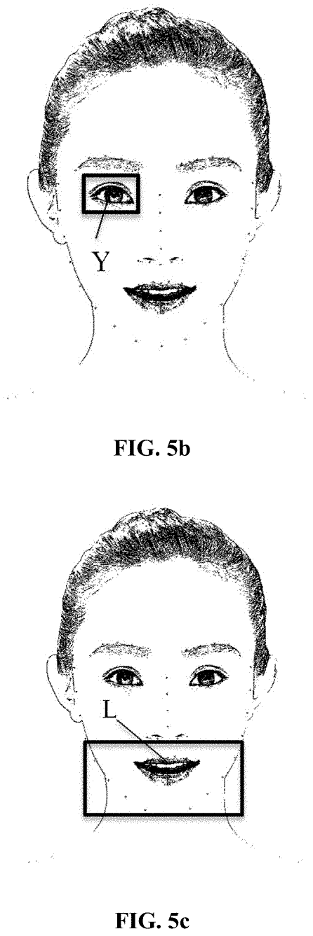

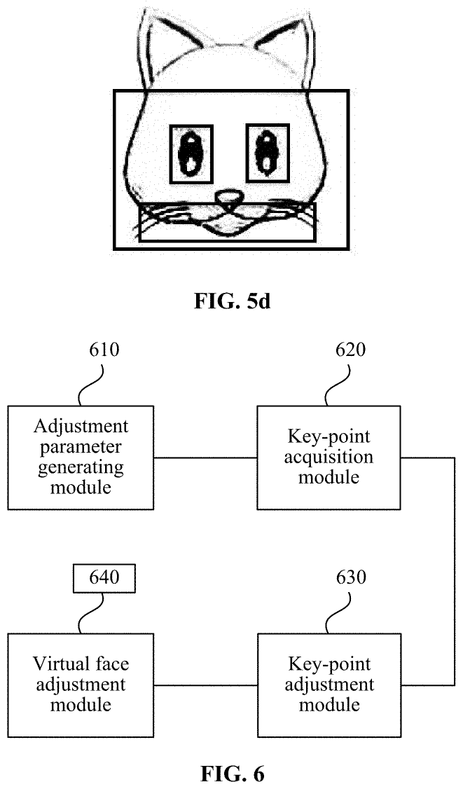

FIG. 5a is a flowchart of an image processing method in a fifth embodiment of the present disclosure. This embodiment may be combined with multiple alternatives in the above embodiments. Referring to FIG. 5a, the method may include the following steps 510, 520, 530, 540, 550 and 560.

The step 510 includes: acquiring current region human face key-point sets for multiple facial regions of the current human face image, historical region human face key-point sets for multiple facial regions of the historical human face image and region facial key-point sets for multiple facial regions of the virtual human face image.

In this embodiment, in order to enable the avatar face image to follow the change of the human face from the historical human face image to the current human face image and make the corresponding action. The current region human face key-point sets for multiple facial regions of the current human face image, the historical region human face key-point sets for multiple facial regions of the historical human face image and the region facial key-point sets for multiple facial regions of the avatar face image, are required to be acquired, and the change of the avatar face key-points matching the change of the human face can be determined, and the adjustment operations to be performed for the multiple avatar face key-points in the avatar face image respectively can be determined.

The step 520 includes: marking off the avatar face image into multiple original grids according to multiple region facial key-point sets.

The step 530 includes: determining target pinpoints for the multiple facial regions of the current human face image, target pinpoints for the multiple facial regions of the historical human face image, and target pinpoints for the multiple facial regions of the avatar face image.

In some embodiments, the determining target pinpoints for the multiple facial regions of the current human face image, target pinpoints for the multiple facial regions of the historical human face image, and target pinpoints for the multiple facial regions of the avatar face image may include: determining, a region locating rectangle corresponding to the current processing facial region in the current human face image, a region locating rectangle corresponding to the current processing facial region in the historical human face image, and a region locating rectangle corresponding to the current processing facial region in the avatar face image; and in the multiple region locating rectangles aforementioned, acquiring corner-points having the same orientation, and using the corner-points having the same orientation as target pinpoints corresponding to the current processing facial regions aforementioned respectively.

In some embodiments, the determining, a region locating rectangle corresponding to the current processing facial region in the current human face image, a region locating rectangle corresponding to the current processing facial region in the historical human face image, and a region locating rectangle corresponding to the current processing facial region in the avatar face image, may include: acquiring an interocular distance in the current human face image, a center key-point of a current processing facial region in the current human face image, an interocular distance in the historical human face image, and a center key-point of a current processing facial region in the historical human face image; and constructing a region locating rectangle corresponding to the current processing facial region of the current human face image by taking a product of the interocular distance in the current human face image and a first proportion value of the current processing facial region as a length, and taking a product of the interocular distance in the current human face image and a second proportion value of the current processing facial region as a width and taking the center key-point of the current processing facial region in the current human face image as a center point, and constructing a region locating rectangle corresponding to the current processing facial region of the historical human face image by taking a product of the interocular distance in the historical human face image and a first proportion value of the current processing facial region as a length, and taking a product of the interocular distance in the historical human face image and a second proportion value of the current processing facial region as a width and taking the center key-point of the current processing facial region in the historical human face image as a center point. Among which, the interocular distance and the center key-point of the current processing facial region are determined by a corresponding human face key-point set; and the center key-point of a facial contour region is a nose tip key-point, the center key-point of an eye peripheral region is an eyeball center key-point, and the center key-point of a mouth peripheral region is an upper lip center key-point.

As an example, the current human face image is taken for illustration. As shown in FIG. 3b, the interocular distance E in the current human face image can be obtained simply by acquiring the coordinates of the human face key-points of both eyes in the current region human face key-point set for the eye peripheral region of the current human face image and making a subtraction therebetween. For the facial contour region, the first proportion value can be set as 2 and the second proportion value can be set as 2.5 according to experience, thereby obtaining a region locating rectangle with a length as 2*E, a width as 2.5*E and a center point as the nose tip key-point S, as shown in FIG. 3c. For the eye peripheral region, the first proportion value may be set to 0.7 and the second proportion value may be set to 0.5 according to experience, thereby obtaining a region locating rectangle with a length as 0.7*E, a width as 0.5*E, and a center point as an eye center key-point Y, as shown in FIG. 5b. For the mouth peripheral region, the first proportion value may be set to 1.7 and the second proportion value may be set to 1.0 according to experience, thereby obtaining a region locating rectangle with a length as 1.7*E, a width as 1.0*E, and a center point as a center key-point L of the upper lip, as shown in FIG. 5c. Apparently, the first proportion value and the second proportion value of multiple facial regions may also be set as other values.

In some embodiments, for the avatar face image, a minimum circumscribed rectangle completely covering the current processing facial region may be determined according to coordinates of multiple avatar face key-points in a region facial key-point set of the current processing facial region, and the minimum circumscribed rectangle may be used as a region locating rectangle corresponding to the current processing facial region of the avatar face image.

In this embodiment, assuming that the avatar face key-points included in the region facial key-point set of the current processing facial region of the avatar face image are (k1, t1), (k2, t2), . . . (Kn, tn), the coordinates of the smallest circumscribed rectangle of the current processing facial region are (min (k1, k2 . . . kn), min (t1, t2 . . . tn)), (min (k1, k2 . . . kn), max (t1, t2 . . . tn)), (max (k1, k2 . . . kn), min (t1, t2 . . . tn)), (max (k1, k2 . . . kn), max (t1, t2 . . . tn)), and the region locating rectangles corresponding to the respective facial regions of the finally obtained avatar face image are shown in FIG. 5d.

The step 540 includes: generating multiple region key-point adjustment acceleration vectors according to a current region human face key-point set corresponding to each facial region and a historical region human face key-point set corresponding to each facial region, target pinpoint corresponding to each facial region in the current human face image, and target pinpoints corresponding to each facial region in the historical human face image, and using the multiple region key-point adjustment acceleration vectors as the region key-point adjustment parameter set.

In some embodiments, the generating multiple region key-point adjustment acceleration vectors according to a current region human face key-point set corresponding to each facial region and a historical region human face key-point set corresponding to each facial region, target pinpoint corresponding to each facial region in the current human face image, and target pinpoints corresponding to each facial region in the historical human face image, and using the multiple region key-point adjustment acceleration vectors as the region key-point adjustment parameter set may include: acquiring first position vectors between each of the current human face key-points corresponding to each facial region in the current region human face key-point set and a target pinpoint corresponding to the respective facial region of the current human face image, and second position vectors between each of the historical human face key-points corresponding to each facial region in the historical region human face key-point set and a target pinpoint corresponding to the respective facial region of the historical human face image; calculating vector differences between each of the second position vectors and a respective one of the first position vectors corresponding to each of the second position vectors; and calculating a product of each of the vector differences and a human face scaling to obtain region key-point adjustment acceleration vectors matching all the historical human face key-points in the historical region human face key-point set corresponding to the respective facial region of the historical human face image, and using the region key-point adjustment acceleration vectors matching all the historical human face key-points in the historical region human face key-point set corresponding to the respective facial region of the historical human face image as the region key-point adjustment parameter set.

As an example, as shown in FIG. 3c, the facial contour region is taken for illustration. It is assumed that both the current human face image and the historical human face image take the vertexes A of their corresponding region locating rectangles as the target pinpoints, first position vectors XnA between each of the current human face key-points Xn for the facial contour region and the corresponding target pinpoint A and second position vectors Xn′A between each of the historical human face key-points Xn′ for the facial contour region and the corresponding target pinpoint A are acquired, and by calculating XnA-Xn′A, the coordinate changes of multiple human face key-points of the facial contour region corresponding to the human face change from the historical human face image to the current human face image are obtained. Considering that the size of the human face in the historical human face image is inconsistent with the size of the avatar face in the avatar face image, it is required to calculate the adjustment acceleration vector of each key-point according to the formula an=(XnA-Xn′A)*Q, that is, adjustment parameters for multiple human face key-points of the facial contour region, making the calculated coordinate changes of the multiple human face key-point fit the size of the avatar face. Q is a human face scaling, and n is an integer greater than or equal to 1

In some embodiments, before the calculating the product of each of the vector differences and the human face scaling, it may further include acquiring an interocular distance in the avatar face image according to a region facial key-point set corresponding to the avatar face image and using a quotient value obtained by dividing the interocular distance in the avatar face image by the interocular distance in the current human face image as the human face scaling.

In this embodiment, since the avatar face image is a static image, the interocular distance in the avatar does not change, and when the size of the human face in front of the camera changes, in order to ensure that the calculated coordinate changes of the multiple human face key-points fit the size of the avatar face, the quotient value of the interocular distance in the avatar face image and the interocular distance in the current human face image can be used as the human face scaling to scale the coordinate changes of the multiple human face key-points.

The step 550 includes: generating multiple adjusted region facial key-point sets according to the multiple region facial key-point sets for multiple facial regions of the avatar face image and the multiple region key-point adjustment parameter sets.

In some embodiments, the generating multiple adjusted region facial key-point sets according to the multiple region facial key-point sets for multiple facial regions of the avatar face image and the multiple region key-point adjustment parameter sets may include: acquiring third position vectors between each avatar face key-point in the region facial key-point set for each facial region of the avatar face image and a target pinpoint corresponding to the respective facial region of the avatar face image; and calculating vector sum values of each of the third position vectors and a matched region key-point adjustment acceleration vector in a corresponding region key-point adjustment parameter set, and calculating the multiple adjusted region facial key-point sets according to all the vector sum values and the target pinpoints corresponding to the corresponding facial regions of the virtual human face image.

In this embodiment, after the human face key-point adjustment parameters in the region key-point adjustment parameter set of each facial region are obtained, the respective human face key-point adjustment parameters are simply added to the corresponding avatar face key-points to obtain the position vector between each adjusted avatar face key-point and the corresponding target pinpoint, and by performing the vector subtraction between the coordinates of the target pinpoints and the position vectors, multiple adjusted avatar face key-points may just be obtained.

The step 560 includes: adjusting the multiple original grids in the avatar face image according to multiple adjusted region facial key-point sets, to generate an adjusted avatar face image corresponding to the current human face image.

In the embodiment of the present disclosure, the multiple region key-point adjustment parameter sets are generated according to current region human face key-point sets and historical region human face key-point sets, for multiple human face regions, of a current human face image and a historical human face image; an avatar face image matching the historical human face image is acquired, where the avatar face image is marked off into multiple original grids according to avatar face key-points; multiple adjusted region facial key-point sets are generated according to the multiple region facial key-point sets and the multiple region key-point adjustment parameter sets for multiple facial regions of the avatar face image; and the multiple original grids in the avatar face image are adjusted according to the multiple adjusted region facial key-point sets, and an adjusted avatar face image corresponding to the current human face image is generated. This embodiment addresses the problem in the related art that the size and shape of the human face in the camera and the size and shape of the avatar face in the avatar face image is limited, and the speed of expression transformation of the avatar driven by the human face is slow. Accordingly, the sizes and shapes of the human face in the camera and the avatar face in the avatar face image are not limited, and the speed and accuracy of the facial-expression transformation of the avatar image driven by the human face is improved, which is adaptable to follow the human face for expression transformation in real-time.

### SIXTH EMBODIMENT

FIG. 6 is a schematic structural diagram of an image processing apparatus in a sixth embodiment of the present disclosure, and this embodiment is applicable to a case where a virtual human face image follows a human face to perform expression transformation in real time. As shown in FIG. 6, the image processing apparatus includes an adjustment parameter generating module 610, a key-point acquisition module 620, a key-point adjustment module 630, and a virtual human face adjustment module 640.

The adjustment parameter generating module 610 is configured to generate a human face key-point adjustment parameter set according to a current human face key-point set and a historical human face key-point set, where the current human face key-point set and the historical human face key-point set correspond to a current human face image and a historical human face image respectively. The key-point acquisition module 620 is configured to acquire an avatar face key-point set of an avatar face image matching the historical human face image, where the avatar face image is marked off into multiple original grids according to avatar face key-points. The key-point adjustment module 630 is configured to generate an adjusted avatar face key-point set matching the avatar face key-point set according to the human face key-point adjustment parameter set. The virtual face adjustment module 640 is configured to adjust the multiple original grids in the avatar face image according to the adjusted avatar face key-point set, to generate an adjusted avatar face image corresponding to the current human face image.

In the embodiment of the present disclosure, a human face key-point adjustment parameter set is generated according to a current human face key-point set and a historical human face key-point set, where the current human face key-point set and the historical human face key-point set correspond to a current human face image and a historical human face image respectively; an avatar face key-point set of an avatar face image matching the historical human face image is acquired, the avatar face image is marked off into multiple original grids according to virtual human face key-points; an adjusted avatar face key-point set matching the avatar face key-point set is generated according to the human face key-point adjustment parameter set; and multiple original grids in the avatar face image are adjusted according to the adjusted avatar face key-point set, and an adjusted avatar face image corresponding to the current human face image is generated. In this way, the problem in the related art is addressed that the size and shape of the human face in the camera or the size and shape of the avatar face in the avatar face image is limited, and that the speed of transformation of the avatar face image following the human face is slow. That is, the sizes and shapes of the human face in the camera and the avatar face in the avatar face image are not limited, and the speed of the facial-expression transformation of the avatar face image following the human face is improved, which is adaptable to a real-time transformation following the human face.

In some embodiments, the avatar face image includes a virtual human face image. The key-point acquisition module 620 is configured to: acquire a virtual human face key-point set of a virtual human face image matching the historical human face image, where the virtual human face image is marked off into multiple original grids according to virtual human face key-points. The key-point adjustment module 630 is configured to generate an adjusted virtual human face key-point set matching the virtual human face key-point set according to the human face key-point adjustment parameter set. The virtual face adjustment module 640 is configured to adjust the multiple original grids in the virtual human face image according to the adjusted virtual human face key-point set, to generate an adjusted virtual human face image corresponding to the current human face image.

In some embodiments, the image processing apparatus further includes a target pinpoint determining module configured to determine a target pinpoint corresponding to a current human face image, a target pinpoint corresponding to the historical human face image, and a target pinpoint corresponding to the virtual human face image before generating a human face key-point adjustment parameter set according to a current human face key-point set and a historical human face key-point set respectively corresponding to the current human face image and the historical human face image. The adjustment parameter generating module 610 is configured to generate multiple human face key-point acceleration vectors that adjust multiple historical human face key-points in the historical human face key-point set to multiple current human face key-points in the current human face key-point set according to the current human face key-point set, the historical human face key-point set, the target pinpoint corresponding to the current human face image, and the target pinpoint corresponding to the historical human face image, and using the multiple human face key-point acceleration vectors as the human face key-point adjustment parameter set. The key-point adjustment module 630 is configured to: generate the adjusted virtual human face key-point set according to the human face key-point adjustment parameter set and the target pinpoint corresponding to the virtual human face image.

In some embodiments, the image processing apparatus further include a target pinpoint determining module. The target pinpoint determining module is configured to determine a human face locating rectangle corresponding to the current human face image, a human face locating rectangle corresponding to the historical human face image, and a human face locating rectangle corresponding to the virtual human face image; and acquire, in the human face locating rectangle corresponding to the current human face image, the human face locating rectangle corresponding to the historical human face image, and the human face locating rectangle corresponding to the virtual human face image, corner-points having the same orientation, and the corner-points having the same orientation are used as the target pinpoint corresponding to the current human face image, the target pinpoint corresponding to the historical human face image, and the target pinpoint corresponding to the virtual human face image respectively.

In some embodiments, the target pinpoint determining module is configured to determine a human face locating rectangle corresponding to the current human face image, a human face locating rectangle corresponding to the historical human face image, and a human face locating rectangle corresponding to the virtual human face image in the current human face image, the historical human face image, and the virtual human face image, respectively, by: acquiring an interocular distance in the current human face image and a nose tip key-point of the current human face image, an interocular distance in the historical human face image and a nose tip key-point of the historical human face image and an interocular distance in the virtual human face image and a nose tip key-point of the virtual human face image; and constructing the human face locating rectangle corresponding to the current human face image by taking a product of the interocular distance in the current human face image and a first proportion value as a length, a product of the interocular distance in the current human face image and a second proportion value as a width, and the nose tip key-point of the current human face image as a center point, the human face locating rectangle corresponding to the historical human face image by taking a product of the interocular distance in the historical human face image and a first proportion value as a length, a product of the interocular distance in the historical human face image and a second proportion value as a width, and the nose tip key-point of the historical human face image as a center point, and the human face locating rectangle corresponding to the virtual human face image by taking a product of the interocular distance in the virtual human face image and a first proportion value as a length, a product of the interocular distance in the virtual human face image and a second proportion value as a width, and the nose tip key-point of the virtual human face image as a center point. The interocular distance in the current human face image and the nose tip key-point of the current human face image are determined through the current human face key-point set, the interocular distance in the historical human face image and the nose tip key-point of the historical human face image are determined through the historical human face key-point set, and the interocular distance in the virtual human face image and the nose tip key-point of the virtual human face image are determined through the virtual human face key-point set.

In some embodiments, the adjustment parameter generating module 610 is configured to: acquire first position vectors between each current human face key-point in the current human face key-point set and the target pinpoint corresponding to the current human face image, and second position vectors between each of the historical human face key-points in the historical human face key-point set and the target pinpoint corresponding to the historical human face image; calculate vector differences between each of the second position vectors and a respective one of the first position vectors corresponding to each of the second position vectors; and calculate a product of each of the vector differences and a human face scaling to obtain the human face key-point acceleration vectors matching each of the historical human face key-points, and use the human face key-point acceleration vectors matching each of the historical human face key-points as the human face key-point adjustment parameter set.

In some embodiments, the key-point adjustment module 630 is further configured to use a quotient value obtained by dividing the interocular distance in the virtual human face image by the interocular distance in the current human face image as the human face scaling before that a product of each of the vector differences and a human face scaling is calculated.

In some embodiments, the key-point adjustment module 630 is configured to acquire third position vectors between each virtual human face key-point in the virtual human face key-point set and the target pinpoint corresponding to the respective virtual human face key-point; and calculate vector sum values of each of the third position vectors and a corresponding human face key-point acceleration vector in the human face key-point adjustment parameter set, and calculate the adjusted virtual human face key-point set according to the vector sum value and the target pinpoint corresponding to the virtual human face image.

In some embodiments, the virtual human face adjustment module 640 is configured to establish a blank image matching the virtual human face image; determine grid deformation modes of the multiple original grids in the virtual human face image according to the adjusted virtual human face key-point set; mark off the blank image into multiple object deformed grids corresponding to the multiple original grids according to the grid deformation modes; and map multiple pixels in each original grid into an object deformed grid corresponding to the respective original grid according to positional correspondence relationships between the multiple original grids and the multiple object deformed grids to obtain the adjusted virtual human face image.

In some embodiments, the virtual face adjustment module 640 is configured to acquire one of the original grids in the virtual human face image as a current processing grid; acquire, on the blank image, an object deformed grid matching the current processing grid, and use the object deformed grid matching the current processing grid as a matching grid; obtain a first vertex sequence corresponding to the current processing grid and a second vertex sequence corresponding to the matching grid, and calculate a mapping relationship matrix between the current processing grid and the matching grid according to the first vertex sequence and the second vertex sequence; and map multiple pixels in the current processing grid to the matching grid according to the mapping relationship matrix, and return to perform the operation of acquiring one of the original grids in the virtual human face image as a current processing grid until all the original grids in the virtual human face image have been processed.

In some embodiments, the adjustment parameter generating module 610 is configured to generate multiple region key-point adjustment parameter sets according to current region human face key-point sets for multiple facial regions of the current human face image and historical region human face key-point sets for multiple facial regions of the historical human face image. The key-point acquisition module 620 is configured to acquire region facial key-point sets for multiple facial regions of the avatar face image matching the historical human face image, and the avatar face image is marked off into multiple original grids according to the avatar face key-points. The key-point adjustment module 630 is configured to generate multiple adjusted region facial key-point sets according to the multiple region facial key-point sets for multiple facial regions of the avatar face image and the multiple region key-point adjustment parameter sets. The virtual face adjustment module 640 is configured to adjust the multiple original grids in the avatar face image according to the multiple adjusted region facial key-point sets, to generate an adjusted avatar face image corresponding to the current human face image.

In some embodiments, the facial region includes at least two of a facial contour region, an eye peripheral region, and a mouth peripheral region.

In some embodiments, the image processing apparatus further includes a target pinpoint determining module configured to determine target pinpoints for the multiple facial regions of the current human face image, target pinpoints for the multiple facial regions of the historical human face image, and target pinpoints for the multiple facial regions of the avatar face image, before that multiple region key-point adjustment parameter sets according to current region human face key-point sets for multiple facial regions of the current human face image and historical region human face key-point sets for multiple facial regions of the historical human face image are generated.

The adjustment parameter generating module 610 is configured to generate multiple region key-point adjustment acceleration vectors according to current region human face key-point sets corresponding to each of the plurality of facial regions and historical region human face key-point sets corresponding to each of the plurality of facial regions, target pinpoints corresponding to each of the plurality of facial regions in the current human face image, and target pinpoints corresponding to each of the plurality of facial regions in the historical human face image and use the multiple region key-point adjustment acceleration vectors as the region key-point adjustment parameter set.

The key-point adjustment module 630 is configured to generate the multiple adjusted region facial key-point sets according to the region key-point adjustment parameter sets corresponding to each of the multiple facial regions, the region facial key-point sets corresponding to each of the multiple facial regions, and the target pinpoints in the avatar face image.

In some embodiments, the target pinpoint determining module is configured to determine a region locating rectangle corresponding to a current processing facial region in the current human face image, a region locating rectangle corresponding to a current processing facial region in the historical human face image, and a region locating rectangle corresponding to a current processing facial region in the avatar face image; and acquire, in a region locating rectangle corresponding to a current processing facial region in the current human face image, in a region locating rectangle corresponding to a current processing facial region in the historical human face image, and in a region locating rectangle corresponding to a current processing facial region in the avatar face image respectively, corner-points having the same orientation, and use the corner-points having the same orientation as a target pinpoint corresponding to a current processing facial region in the current human face image, a target pinpoint corresponding to a current processing facial region in the historical human face image, and a target pinpoint corresponding to a current processing facial region in the avatar face image respectively.

In some embodiments, the target pinpoint determining module includes a first determining unit and a second determining unit. The first determining unit is configured to acquire, an interocular distance in the current human face image and a center key-point of a current processing facial region in the current human face image, an interocular distance in the historical human face image and a center key-point of a current processing facial region in the historical human face image; construct the region locating rectangle corresponding to the current processing facial region of the current human face image by taking a product of the interocular distance in the current human face image and a first proportion value of the current processing facial region as a length, taking a product of the interocular distance in the current human face image and a second proportion value of the current processing facial region as a width and taking the center key-point of the current processing facial region in the current human face image as a center point; construct a region locating rectangle corresponding to a current processing facial region of the historical human face image by taking a product of the interocular distance in the historical human face image and a first proportion value of the current processing facial region as a length, taking a product of the interocular distance in the historical human face image and a second proportion value of the current processing facial region as a width and taking a center key-point of a current processing facial region in the historical human face image as a center point. Among which, the interocular distance in the current human face image and the center key-point of the current processing facial region in the current human face image are determined by corresponding current region human face key-point sets; the interocular distance in the historical human face image and the center key-point of the current processing facial region in the historical human face image are determined by corresponding historical region human face key-point sets. The center key-point of a facial contour region is a nose tip key-point, the center key-point of an eye peripheral region is an eyeball center key-point, and the center key-point of a mouth peripheral region is an upper lip center key-point. The second determining unit is configured to determine, according to coordinates of multiple avatar face key-points in a region facial key-point set of a current processing facial region, a minimum circumscribed rectangle completely covering the current processing facial region, and use the minimum circumscribed rectangle as a region locating rectangle corresponding to the current processing facial region of the avatar face image.

In some embodiments, the adjustment parameter generating module 610 is configured to acquire first position vectors between each current human face key-point in the current region human face key-point set corresponding to each facial region and a target pinpoint corresponding to the respective facial region of the current human face image, and second position vectors between each of the historical human face key-points in the historical region human face key-point set and a target pinpoint corresponding to the respective facial region of the historical human face image; calculate vector differences between each of the second position vectors and a respective one of the first position vectors corresponding to each of the second position vectors; and calculate a product of each of the vector differences and a human face scaling to obtain region key-point adjustment acceleration vectors matching all the historical human face key-points in the historical region human face key-point set corresponding to the respective facial region of the historical human face image, and use the region key-point adjustment acceleration vectors matching all the historical human face key-points in the historical region human face key-point set corresponding to the respective facial region of the historical human face image as the region key-point adjustment parameter set.

In some embodiments, the image processing apparatus further includes a scaling calculation module, configured to acquire an interocular distance in the avatar face image according to a region facial key-point set corresponding to the avatar face image before that the product of each of the vector differences and the human face scaling is calculated and that the quotient value obtained by dividing the interocular distance in the avatar face image by the interocular distance in the current human face image is used as the human face scaling.

In some embodiments, the key-point adjustment module 630 is configured to acquire third position vectors between each avatar face key-point in the region facial key-point set for each facial region of the avatar face image and a target pinpoint corresponding to the respective facial region of the avatar face image; and calculate vector sum values of each of the third position vectors and a matched region key-point adjustment acceleration vector in the corresponding region key-point adjustment parameter set, and calculate the multiple adjusted region facial key-point sets according to all the vector sum values and the target pinpoints corresponding to the corresponding facial regions of the avatar face image.

In some embodiments, the virtual face adjustment module 640 is configured to: establish a blank image matching the avatar face image; determine grid deformation modes of the multiple original grids in the avatar face image according to the multiple adjusted region facial key-point sets; mark off the blank image into multiple object deformed grids corresponding to the multiple original grids according to the grid deformation modes; and map multiple pixels in all the original grids into multiple object deformed grids corresponding to the respective original grids according to positional correspondence relationships between the multiple original grids and the multiple object deformed grids to obtain the adjusted avatar face image.

In some embodiments, the virtual face adjustment module 640 is configured to map multiple pixels in all the original grid into multiple object deformed grids corresponding to the respective original grids according to positional correspondence relationships between the multiple original grids and the multiple object deformed grids to obtain the adjusted avatar face image by: acquiring one of the original grids in the avatar face image as a current processing grid; acquiring, on the blank image, an object deformed grid matching the current processing grid, and using the object deformed grid matching the current processing grid as a matching grid; obtaining a first vertex sequence corresponding to the current processing grid and a second vertex sequence corresponding to the matching grid, and calculating a mapping relationship matrix between the current processing grid and the matching grid according to the first vertex sequence and the second vertex sequence; and mapping multiple pixels in the current processing grid to the matching grid according to the mapping relationship matrix, and returning to perform the operation of acquiring one of the original grids in the avatar face image as a current processing grid until all the plurality of original grids in the avatar face image have been processed.

The image processing apparatus according to the embodiments of the present disclosure can execute the image processing method according to any embodiment of the present disclosure, and has corresponding functional modules to execute the method.

### SEVENTH EMBODIMENT

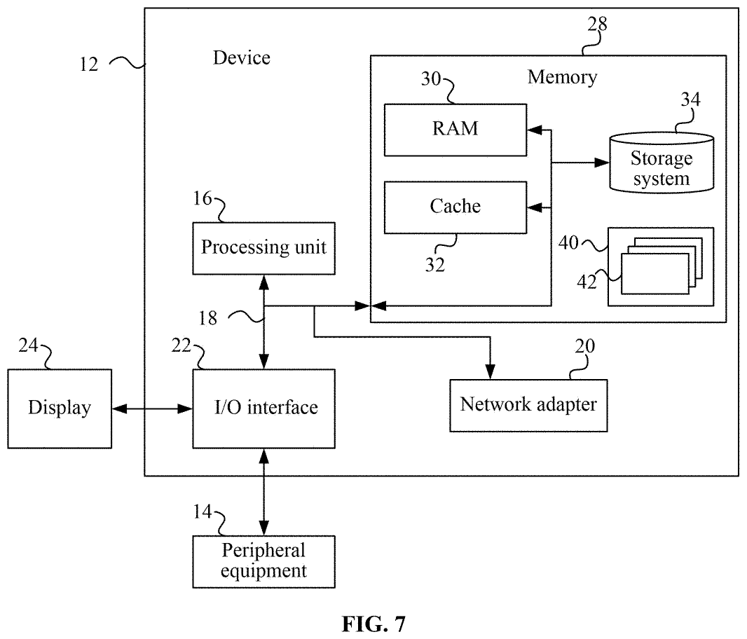

FIG. 7 is a schematic diagram of a device according to a seventh embodiment of the present disclosure. FIG. 7 shows a block diagram of an exemplary device 12 suitable for implementing the embodiments of the present disclosure. The device 12 shown in FIG. 7 is merely an example and should not be deemed as imposing any limitations on the functionality and the scope of use of the embodiments of the present disclosure.

As shown in FIG. 7, the device 12 is represented in a form of a general-purpose computing apparatus. Components of the device 12 may include, but are not limited to, at least one processor or processing unit 16, a system memory 28 and a bus 18 connecting different system components (including the system memory 28 and the processing unit 16).

The bus 18 represents one or more of several types of bus structures, including a memory bus or memory controller, a peripheral bus, a graphics acceleration port, a processor, or a local bus using any of a variety of bus structures. For example, these architectures include, but are not limited to, an industrial standard architecture (ISA) bus, a micro channel architecture (MCA) bus, an enhanced ISA bus, a video electronics standards association (VESA) local bus, and a peripheral component interconnect (PCI) bus.

The device 12 includes multiple types of computer system readable media. These media may be any available media that can be accessed by the device 12. These media include transitory and non-transitory media, volatile and non-volatile media, and removable and non-removable media.

The system memory 28 may include a computer system-readable medium in the form of volatile memory, such as a random access memory (RAM) 30 and/or a cache memory 32. The device 12 may further include other removable/non-removable, volatile/non-volatile computer system storage medium. For example only, the storage system 34 may be configured to read and write non-removable, non-volatile magnetic media (not shown in FIG. 7, commonly referred to as a “hard drive”). Although not shown in FIG. 7, a magnetic disk drive configured to read and write a removable non-volatile magnetic disk (e.g., floppy disk) and an optical disk drive configured to read and write a removable non-volatile optical disk (e.g., a compact disc-read only memory, (CD-ROM), a digital video disk read-only memory (DVD-ROM), or other optical media) may be provided. In these cases, each drive may be connected to the bus 18 via one or more data medium interfaces. The memory 28 may include at least one program product having a set of (e.g., at least one) program modules configured to perform the functions of the multiple embodiments of the present disclosure.

A program/utility 40, having a set of (at least one) program modules 42, may be stored, for example, in the system memory 28, such program modules 42 include, but is not limited to, an operating system, one or more application programs, other program modules, and program data, each or a combination of these examples may include an implementation of a network environment. The program modules 42 generally performs the described functions and/or methods in the embodiments of the present disclosure.

The device 12 may communicate with one or more external devices 14 (for example, a keyboard, a pointing terminal, a display 24), and may also communicate with one or more terminals that enable a user to interact with the device 12, and/or with any device (for example, a network interface controller or a modem) that enables the device 12 to communicate with one or more other computing devices. Such communication may be performed through an input/output (I/O) interface 22. Further, the device 12 may also communicate with one or more networks, such as a local area network (LAN), a wide area network (WAN), and/or a public network, such as the Internet, through a network adapter 20. As shown, the network adapter 20 communicates with other modules of the device 12 via the bus 18. Other hardware and/or software modules, although not shown in the figures, may be used in conjunction with the device 12. The other hardware and/or software modules include, but are not limited to, micro-codes, a terminal driver, a redundant processing unit, an external disk drive array, a redundant arrays of independent disks (RAID) system, a tape driver, a data backup storage system and the like.

The processing unit 16 runs a program stored in the system memory 28, to thereby executing multiple functional applications and data processing, for example, implementing an image processing method according to the embodiments of the present disclosure.

For example, the image processing method is implemented, which includes:

generating a human face key-point adjustment parameter set according to a current human face key-point set and a historical human face key-point set, where the current human face key-point set and the historical human face key-point set correspond to a current human face image and a historical human face image respectively;

acquiring an avatar face key-point set of an avatar face image matching the historical human face image, where the avatar face image is marked off into multiple original grids according to avatar face key-points;

generating an adjusted avatar face key-point set matching the avatar face key-point set according to the human face key-point adjustment parameter set; and

adjusting the multiple original grids in the avatar face image according to the adjusted avatar face key-point set, to generate an adjusted avatar face image corresponding to the current human face image.

### EIGHTH EMBODIMENT

In an eighth embodiment of the present disclosure, it is further disclosed a computer storage medium on which a computer program is stored. when the computer program is executed by a processor, an image processing method is implemented. For example, the image processing method includes:

generating a human face key-point adjustment parameter set according to a current human face key-point set and a historical human face key-point set, where the current human face key-point set and the historical human face key-point set correspond to a current human face image and a historical human face image respectively;

acquiring an avatar face key-point set of an avatar face image matching the historical human face image, where the avatar face image is marked off into multiple original grids according to avatar face key-points;

generating an adjusted avatar face key-point set matching the avatar face key-point set according to the human face key-point adjustment parameter set; and adjusting the multiple original grids in the avatar face image according to the adjusted avatar face key-point set, to generate an adjusted avatar face image corresponding to the current human face image.

The computer storage medium in embodiments of the present disclosure may be embodied as any combination of one or more computer-readable media. The computer-readable media may be a computer-readable signal medium or a computer-readable storage medium. The computer-readable storage medium may be, but is not limited to, an electrical, magnetic, optical, electromagnetic, infrared or semiconductor system, apparatus or component, or any combination thereof. Examples of computer-readable storage medium (non-exhaustive list) include electrical connections having one or more wires, portable computer disks, hard disks, random access memories (RAMs), read-only memories (ROMs), erasable programmable read-only memories (EPROMs, or flash memories), optical fibers, portable compact disk read-only memories (CD-ROM), optical storage component, magnetic storage component, or any suitable combination thereof. In this document, the computer-readable storage medium may be any tangible medium including or storing a program. The program may be used by or used in conjunction with an instruction execution system, apparatus or component.

The computer-readable signal medium may include a data signal propagated in a baseband or as part of a carrier. The data signal carries computer-readable program codes. The data signal propagated in this manner may be in multiple forms and includes, but is not limited to, an electromagnetic signal, an optical signal, or any suitable combination thereof. The computer-readable signal medium may further be any computer-readable medium other than the computer-readable storage medium. The computer-readable medium can send, propagate, or transmit the program used by or used in conjunction with the instruction execution system, apparatus, or component.

The program codes included on the computer-readable medium may be transmitted by using any suitable medium, including, but not limited to, a wireless medium, a wired medium, an optical cable, radio frequency (RF), and the like, or any suitable combination thereof.

Computer program codes for performing the operations of the present disclosure may be written in one or more programming languages or a combination thereof, the programming languages including object-oriented programming languages such as Java, Smalltalk, C++, and further including conventional procedural programming languages such as “C” programming language or similar programming languages. The program codes may be executed entirely on a user computer, partly on a user computer, as a stand-alone software package, partly on a user computer and partly on a remote computer, or entirely on a remote computer or a server. In a case involving a remote computer, the remote computer may be connected to the user's computer through any kinds of network, including a local area network (LAN) or a wide area network (WAN), or may be connected to an external computer (e.g., connected through Internet by using an Internet service provider).

1. An image processing method, comprising:
generating a human face key-point adjustment parameter set according to a current human face key-point set and a historical human face key-point set, wherein the current human face key-point set and the historical human face key-point set correspond to a current human face image and a historical human face image respectively;
acquiring an avatar face key-point set of an avatar face image matching the historical human face image, wherein the avatar face image is marked off into a plurality of original grids according to avatar face key-points;
generating an adjusted avatar face key-point set matching the avatar face key-point set according to the human face key-point adjustment parameter set; and
adjusting the plurality of original grids in the avatar face image according to the adjusted avatar face key-point set, to generate an adjusted avatar face image corresponding to the current human face image.

2. The method of claim 1, wherein the avatar face image comprises a virtual human face image;
the acquiring an avatar face key-point set of an avatar face image matching the historical human face image, wherein the avatar face image is marked off into a plurality of original grids according to avatar face key-points comprises:
acquiring a virtual human face key-point set of a virtual human face image matching the historical human face image, wherein the virtual human face image is marked off into a plurality of original grids according to virtual human face key-points;
the generating an adjusted avatar face key-point set matching the avatar face key-point set according to the human face key-point adjustment parameter set comprises:
generating an adjusted virtual human face key-point set matching the virtual human face key-point set according to the human face key-point adjustment parameter set; and
the adjusting the plurality of original grids in the avatar face image according to the adjusted avatar face key-point set, to generate an adjusted avatar face image corresponding to the current human face image comprises:
adjusting the plurality of original grids in the virtual human face image according to the adjusted virtual human face key-point set, to generate an adjusted virtual human face image corresponding to the current human face image.

3. The method of claim 2, wherein before the generating a human face key-point adjustment parameter set according to a current human face key-point set and a historical human face key-point set, wherein the current human face key-point set and the historical human face key-point set correspond to a current human face image and a historical human face image respectively, the method further comprises:
determining a target pinpoint corresponding to the current human face image, a target pinpoint corresponding to the historical human face image, and a target pinpoint corresponding to the virtual human face image;
the generating a human face key-point adjustment parameter set according to a current human face key-point set and a historical human face key-point set, wherein the current human face key-point set and the historical human face key-point set correspond to a current human face image and a historical human face image respectively, comprises:
generating a plurality of human face key-point acceleration vectors that adjust a plurality of historical human face key-points in the historical human face key-point set to a plurality of current human face key-points in the current human face key-point set according to the current human face key-point set, the historical human face key-point set, the target pinpoint corresponding to the current human face image, and the target pinpoint corresponding to the historical human face image, and using the plurality of human face key-point acceleration vectors as the human face key-point adjustment parameter set;
the generating an adjusted virtual human face key-point set matching the virtual human face key-point set according to the human face key-point adjustment parameter set, comprises:
generating an adjusted virtual human face key-point set according to the human face key-point adjustment parameter set and the target pinpoint corresponding to the virtual human face image.

4. The method of claim 3, wherein the determining a target pinpoint corresponding to the current human face image, a target pinpoint corresponding to the historical human face image, and a target pinpoint corresponding to the virtual human face image comprises:
determining a human face locating rectangle corresponding to the current human face image, a human face locating rectangle corresponding to the historical human face image, and a human face locating rectangle corresponding to the virtual human face image in the current human face image, the historical human face image, and the virtual human face image, respectively;
acquiring, in the human face locating rectangle corresponding to the current human face image, the human face locating rectangle corresponding to the historical human face image, and the human face locating rectangle corresponding to the virtual human face image respectively, corner-points having the same orientation, and using the corner-points having the same orientation as the target pinpoint corresponding to the current human face image, the target pinpoint corresponding to the historical human face image, and the target pinpoint corresponding to the virtual human face image respectively.

5. The method of claim 4, wherein the determining a human face locating rectangle corresponding to the current human face image, a human face locating rectangle corresponding to the historical human face image, and a human face locating rectangle corresponding to the virtual human face image in the current human face image, comprises: acquiring an interocular distance in the current human face image and a nose tip key-point of the current human face image, an interocular distance in the historical human face image and a nose tip key-point of the historical human face image and an interocular distance in the virtual human face image and a nose tip key-point of the virtual human face image in the current human face image, the historical human face image and the virtual human face image, respectively; and
constructing the human face locating rectangle corresponding to the current human face image by taking a product of the interocular distance in the current human face image and a first proportion value as a length, a product of the interocular distance in the current human face image and a second proportion value as a width, and the nose tip key-point of the current human face image as a center point; constructing the human face locating rectangle corresponding to the historical human face image by taking a product of the interocular distance in the historical human face image and the first proportion value as a length, a product of the interocular distance in the historical human face image and the second proportion value as a width, and the nose tip key-point of the historical human face image as a center point; constructing the human face locating rectangle corresponding to the virtual human face image by taking a product of the interocular distance in the virtual human face image and a first proportion value as a length, a product of the interocular distance in the virtual human face image and a second proportion value as a width, and the nose tip key-point of the virtual human face image as a center point;
wherein the interocular distance in the current human face image and the nose tip key-point of the current human face image are determined through the current human face key-point set, the interocular distance in the historical human face image and the nose tip key-point of the historical human face image are determined through the historical human face key-point set, and the interocular distance in the virtual human face image and the nose tip key-point of the virtual human face image are determined through the virtual human face key-point set.

6. The method of claim 3, wherein the generating a plurality of human face key-point acceleration vectors that adjust a plurality of historical human face key-points in the historical human face key-point set to a plurality of current human face key-points in the current human face key-point set according to the current human face key-point set, the historical human face key-point set, the target pinpoint corresponding to the current human face image, and the target pinpoint corresponding to the historical human face image, and using the plurality of human face key-point acceleration vectors as the human face key-point adjustment parameter set, comprises:
acquiring first position vectors between each current human face key-point in the current human face key-point set and the target pinpoint corresponding to the current human face image, and second position vectors between each of the historical human face key-points in the historical human face key-point set and the target pinpoint corresponding to the historical human face image;
calculating vector differences between each of the second position vectors and a respective one of the first position vectors corresponding to each of the second position vectors; and
calculating a product of each of the vector differences and a human face scaling to obtain the human face key-point acceleration vectors matching each of the historical human face key-points, and using the human face key-point acceleration vectors matching each of the historical human face key-points as the human face key-point adjustment parameter set.

7. The method of claim 6, before the calculating a product of each of the vector differences and a human face scaling, further comprising:
using a quotient value obtained by dividing the interocular distance in the virtual human face image by the interocular distance in the current human face image as the human face scaling.

8. The method of claim 7, wherein the generating an adjusted virtual human face key-point set according to the human face key-point adjustment parameter set and the target pinpoint corresponding to the virtual human face image comprises:
acquiring third position vectors between each virtual human face key-point in the virtual human face key-point set and the target pinpoint corresponding to the virtual human face image;
calculating vector sum values of each of the third position vectors and a corresponding human face key-point acceleration vector in the human face key-point adjustment parameter set, and calculating the adjusted virtual human face key-point set according to the vector sum values and the target pinpoint corresponding to the virtual human face image.

9. The method of claim 2, wherein the adjusting the plurality of original grids in the virtual human face image according to the adjusted virtual human face key-point set, to generate an adjusted virtual human face image corresponding to the current human face image comprises:
establishing a blank image matching the virtual human face image;
determining grid deformation modes of the plurality of original grids in the virtual human face image according to the adjusted virtual human face key-point set;
marking off the blank image into a plurality of object deformed grids corresponding to the plurality of original grids according to the grid deformation modes; and
mapping a plurality of pixels in each original grid into an object deformed grid corresponding to the respective original grid according to positional correspondence relationships between the plurality of original grids and the plurality of object deformed grids to obtain the adjusted virtual human face image.

10. The method of claim 9, wherein the mapping a plurality of pixels in each original grid into an object deformed grid corresponding to the respective original grid according to positional correspondence relationships between the plurality of original grids and the plurality of object deformed grids to obtain the adjusted virtual human face image comprises:
acquiring one of the original grids in the virtual human face image as a first current processing grid;
acquiring, on the blank image, an object deformed grid matching the first current processing grid, and using the object deformed grid matching the first current processing grid as a first matching grid;
obtaining a first vertex sequence corresponding to the first current processing grid and a second vertex sequence corresponding to the first matching grid, and calculating a mapping relationship matrix between the first current processing grid and the first matching grid according to the first vertex sequence and the second vertex sequence; and
mapping a plurality of pixels in the first current processing grid to the first matching grid according to the mapping relationship matrix, and returning to perform the operation of acquiring one of the original grids in the virtual human face image as a first current processing grid until all the plurality of original grids in the virtual human face image have been processed.

11. The method of claim 1, wherein
the generating a human face key-point adjustment parameter set according to a current human face key-point set and a historical human face key-point set, wherein the current human face key-point set and the historical human face key-point set correspond to a current human face image and a historical human face image respectively comprises: generating a plurality of region key-point adjustment parameter sets according to current region human face key-point sets for a plurality of facial regions of the current human face image and historical region human face key-point sets for a plurality of facial regions of the historical human face image;
the acquiring an avatar face key-point set of an avatar face image matching the historical human face image comprises acquiring a plurality of region facial key-point sets for a plurality of facial regions of the avatar face image matching the historical human face image;
the generating an adjusted avatar face key-point set matching the avatar face key-point set according to the human face key-point adjustment parameter set comprises: generating a plurality of adjusted region facial key-point sets according to the plurality of region facial key-point sets for a plurality of facial regions of the avatar face image and the plurality of region key-point adjustment parameter sets; and
the adjusting the plurality of original grids in the avatar face image according to the adjusted avatar face key-point set, to generate an adjusted avatar face image corresponding to the current human face image comprises adjusting the plurality of original grids in the avatar face image according to the plurality of adjusted region facial key-point sets, to generate an adjusted avatar face image corresponding to the current human face image;
wherein the facial region comprises at least two of a facial contour region, an eye peripheral region, and a mouth peripheral region.

12. (canceled)

13. The method of claim 11, before the generating a plurality of region key-point adjustment parameter sets according to current region human face key-point sets for a plurality of facial regions of the current human face image and historical region human face key-point sets for a plurality of facial regions of the historical human face image, the method further comprising:
determining target pinpoints for the plurality of facial regions of the current human face image, target pinpoints for the plurality of facial regions of the historical human face image, and target pinpoints for the plurality of facial regions of the avatar face image;
wherein the generating a plurality of region key-point adjustment parameter sets according to current region human face key-point sets for a plurality of facial regions of the current human face image and historical region human face key-point sets for a plurality of facial regions of the historical human face image comprises:
generating a plurality of region key-point adjustment acceleration vectors according to a current region human face key-point set and a historical region human face key-point set corresponding to each facial region, a target pinpoint corresponding to the respective facial region in a current human face image, and a target pinpoint corresponding to the respective facial region in a historical human face image, and using the plurality of region key-point adjustment acceleration vectors as a region key-point adjustment parameter set; and
wherein the generating a plurality of adjusted region facial key-point sets according to the plurality of region facial key-point sets for a plurality of facial regions of the avatar face image and the plurality of region key-point adjustment parameter sets, comprises:
generating a plurality of adjusted region facial key-point sets according to the region key-point adjustment parameter sets corresponding to each of the plurality of facial regions, and the region facial key-point sets corresponding to each of the plurality of facial regions and the target pinpoints in the avatar face image.

14. The method of claim 13, wherein the determining target pinpoints for the plurality of facial regions of the current human face image, target pinpoints for the plurality of facial regions of the historical human face image, and target pinpoints for the plurality of facial regions of the avatar face image, comprises:
determining a region locating rectangle corresponding to a current processing facial region in the current human face image, a region locating rectangle corresponding to a current processing facial region in the historical human face image, and a region locating rectangle corresponding to a current processing facial region in the avatar face image; and
acquiring, in a region locating rectangle corresponding to a current processing facial region in the current human face image, in a region locating rectangle corresponding to a current processing facial region in the historical human face image, and in a region locating rectangle corresponding to a current processing facial region in the avatar face image respectively, corner-points in the same orientation, and using the corner-points in the same orientation as a target pinpoint corresponding to a current processing facial region in the current human face image, a target pinpoint corresponding to a current processing facial region in the historical human face image, and a target pinpoint corresponding to a current processing facial region in the avatar face image respectively.

15. The method of claim 14, wherein the determining a region locating rectangle corresponding to a current processing facial region in the current human face image, a region locating rectangle corresponding to a current processing facial region in the historical human face image, and a region locating rectangle corresponding to a current processing facial region in the avatar face image comprises:
acquiring, an interocular distance in the current human face image, a center key-point of the current processing facial region of the current human face image, an interocular distance in the historical human face image, and a center key-point of a current processing facial region of the historical human face image;
constructing the region locating rectangle corresponding to the current processing facial region of the current human face image by taking a product of the interocular distance in the current human face image and a first proportion value of the current processing facial region as a length, taking a product of the interocular distance in the current human face image and a second proportion value of the current processing facial region as a width and taking the center key-point of the current processing facial region in the current human face image as a center point; constructing a region locating rectangle corresponding to the current processing facial region of the historical human face image by taking a product of the interocular distance in the historical human face image and the first proportion value of the current processing facial region as a length, taking a product of the interocular distance in the historical human face image and the second proportion value of the current processing facial region as a width and taking the center key-point of the current processing facial region in the historical human face image as a center point;
wherein the interocular distance in the current human face image and the center key-point of the current processing facial region in the current human face image are determined by corresponding current region human face key-point sets; the interocular distance in the historical human face image and the center key-point of the current processing facial region in the historical human face image are determined by corresponding historical region human face key-point sets; a center key-point of a facial contour region is a nose tip key-point, a center key-point of an eye peripheral region is an eyeball center key-point, and a center key-point of a mouth peripheral region is an upper lip center key-point; and
determining, according to coordinates of a plurality of avatar face key-points in a region facial key-point set of the current processing facial region, a minimum circumscribed rectangle completely covering the current processing facial region, and using the minimum circumscribed rectangle as a region locating rectangle corresponding to the current processing facial region of the avatar face image.

16. The method of claim 13, wherein the generating a plurality of region key-point adjustment acceleration vectors according to a current region human face key-point set and a historical region human face key-point set corresponding to each facial region, a target pinpoint corresponding to the respective facial region in a current human face image, and a target pinpoint corresponding to the respective facial region in a historical human face image, and using the plurality of region key-point adjustment acceleration vectors as a region key-point adjustment parameter set comprises:
acquiring first position vectors between each current human face key-point in the current region human face key-point set corresponding to each facial region and a target pinpoint corresponding to the respective facial region of the current human face image, and second position vectors between each of the historical human face key-points in the historical region human face key-point set and a target pinpoint corresponding to the respective facial region of the historical human face image;
calculating vector differences between each of the second position vectors and a respective one of the first position vectors corresponding to each of the second position vectors; and
calculating a product of each of the vector differences and a human face scaling to obtain region key-point adjustment acceleration vectors matching all the historical human face key-points in the historical region human face key-point set corresponding to the respective facial region of the historical human face image, and using the region key-point adjustment acceleration vectors matching all the historical human face key-points in the historical region human face key-point set corresponding to the respective facial region of the historical human face image as the region key-point adjustment parameter set.

17. The method of claim 16, before the calculating a product of each of the vector differences and the human face scaling, the method further comprising:
acquiring an interocular distance in the avatar face image according to a region facial key-point set corresponding to the avatar face image; and
using a quotient value obtained by dividing the interocular distance in the avatar face image by the interocular distance in the current human face image as the human face scaling.

18. The method of claim 17, wherein the generating a plurality of adjusted region facial key-point sets according to the plurality of region key-point adjustment parameter sets for a plurality of facial regions of the avatar face image and the plurality of region facial key-point sets comprises:
acquiring third position vectors between each avatar face key-point in the region facial key-point set for each facial region of the avatar face image and a target pinpoint corresponding to the respective facial region of the avatar face image; and
calculating vector sum values of each of the third position vectors and a matched region key-point adjustment acceleration vector in a corresponding region key-point adjustment parameter set, and calculating the plurality of adjusted region facial key-point sets according to all the vector sum values and the target pinpoints corresponding to the corresponding facial regions of the virtual human face image.

19. The method of claim 11, wherein the adjusting the plurality of original grids in the avatar face image according to the plurality of adjusted region facial key-point sets, to generate an adjusted avatar face image corresponding to the current human face image comprises:
establishing a blank image matching the avatar face image;
determining grid deformation modes of the plurality of original grids in the avatar face image according to the plurality of adjusted region facial key-point sets;
marking off the blank image into a plurality of object deformed grids corresponding to the plurality of original grids according to the grid deformation modes;
mapping a plurality of pixels in each original grid into an object deformed grid corresponding to the respective original grid according to positional correspondence relationships between the plurality of original grids and the plurality of object deformed grids to obtain the adjusted avatar face image.

20. The method of claim 19, wherein the mapping a plurality of pixels in each original grid into an object deformed grid corresponding to the respective original grid according to positional correspondence relationships between the plurality of original grids and the plurality of object deformed grids to obtain the adjusted avatar face image comprises:
acquiring one of the original grids in the avatar face image as a second current processing grid;
acquiring, in the blank image, an object deformed grid matching the second current processing grid, and using the object deformed grid matching the second current processing grid as a second matching grid;
obtaining a first vertex sequence corresponding to the second current processing grid and a second vertex sequence corresponding to the second matching grid, and calculating a mapping relationship matrix between the second current processing grid and the second matching grid according to the first vertex sequence and the second vertex sequence;
mapping a plurality of pixels in the second current processing grid to the second matching grid according to the mapping relationship matrix, and perform the operation of acquiring one of the original grids in the avatar face image as a second current processing grid until all the plurality of original grids in the avatar face image have been processed.

21. An image processing apparatus, comprising:
at least one processor; and
a storage device configured to store at least one program,
wherein the at least one program, when executed by the at least one processor, causes the at least one processor to implement:
generate a human face key-point adjustment parameter set according to a current human face key-point set and a historical human face key-point set, wherein the current human face key-point set and the historical human face key-point set correspond to a current human face image and a historical human face image respectively;
acquire an avatar face key-point set of an avatar face image matching the historical human face image, wherein the avatar face image is marked off into a plurality of original grids according to virtual human face key-points;
generate an adjusted avatar face key-point set matching the avatar face key-point set according to the human face key-point adjustment parameter set; and
adjust the plurality of original grids in the avatar face image according to the adjusted avatar face key-point set, to generate an adjusted avatar face image corresponding to the current human face image.

22-25. (canceled)
